(19) United States
(12) Patent Application Publication
(10) Pub. No.: US 2024/0375725 A1
(43) Pub. Date: Nov. 14, 2024

(54) Utility Rack with Removable Panels

(71) Applicant: Kuat Innovations LLC, Springfield, MO (US)

(72) Inventors: Luke Kuschmeader, Springfield, MO (US); Jonathan Graif, Springfield, MO (US); Jamie Kummerfeld, Greeley, CO (US)

(73) Assignee: Kuat Innovations LLC, Springfield, MO (US)

(21) Appl. No.: 18/655,464

(22) Filed: May 6, 2024

Related U.S. Application Data
(60) Provisional application No. 63/500,667, filed on May 8, 2023.
(60) Provisional application No. 63/580,454, filed on Sep. 5, 2023.

(51) Int. Cl. B62D 33/02

(52) U.S. Cl. CPC B62D 33/0207

(57) ABSTRACT

A utility rack for use with a truck may incorporate removable panels to partially or fully enclose the cargo bed of the truck. The utility rack may comprise a structural frame for supporting cargo, and removable panels for attaching to the structural frame to form a shell. Portions of the structural frame may be available to support cargo while the removable panels are attached to the structural frame. In some versions of the utility rack, the removable panels may be attached to and detached from the structural frame while cargo is supported by the structural frame. In some versions the utility rack with the removable panels attached creates a weather resistant shell on the cargo bed of the truck.

### CROSS-REFERENCE TO RELATED APPLICATIONS

This application claims the benefit of U.S. Provisional Patent Application No. 63/500,667 filed on May 8, 2023, and of U.S. Provisional Patent Application No. 63/580,454 filed on Sep. 5, 2023.

### BACKGROUND

### Field of the Invention

This disclosure is in the field of cargo racks for use with vehicles such as trucks. More specifically, this disclosure is in the field of cargo racks for attachment to the sidewalls of a truck bed. More specifically, this disclosure is in the field of cargo racks configured to convert to a truck cap or shell for the truck bed or cargo area.

### Description of the Related Art

Utility racks are known for mounting to the cargo beds of trucks for attaching cargo, equipment, or other items to the truck. These utility racks provide a support structure for but are otherwise open. Similarly, caps or shells are also known for attaching to the cargo beds of trucks for providing weather resistant shelter to items in the cargo bed. Previously existing cargo racks or truck caps with cargo carrying features are not capable of conversion from a utility rack to an enclosed cap without interfering with the carrying of cargo on the rack. There is an unmet need for a utility rack that receives removable panels for weather-resistance, security enclosure, or other purposes, but without interfering with the use of the utility rack for carrying cargo.

### SUMMARY OF THE INVENTION

In various embodiments, the inventive utility rack comprises a structural frame for supporting cargo, and removable panels for attaching to the structural frame to form a shell. In various embodiments, portions of the structural frame are available to support cargo while the removable panels are attached to the structural frame. In various embodiments, the removable panels may be attached to and detached from the structural frame while cargo is supported by the structural frame.

### BRIEF DESCRIPTION OF THE DRAWINGS

FIG. 1 is a perspective view of an embodiment of the inventive utility rack mounted on a truck.

FIG. 2A is a perspective view of an embodiment of the inventive utility rack with attached removable panels.

FIG. 2B is a side view of an embodiment of the inventive utility rack with attached removable panels.

FIG. 2C is a rear view of an embodiment of the inventive utility rack with attached removable panels.

FIG. 2D is a front view of an embodiment of the inventive utility rack with attached removable panels.

FIG. 2E is a top view of an embodiment of the inventive utility rack with attached removable panels.

FIG. 2F is a perspective view of an embodiment of the inventive utility rack with the removable panels removed from the rack.

FIG. 2G is a cross-sectional view through a rear and roof panel portion of an embodiment of the inventive utility rack.

FIG. 2H is a cross-sectional view through a front and roof panel portion of an embodiment of the inventive utility rack.

FIG. 2I is a cross-sectional view through a side and roof panel portion of an embodiment of the inventive utility rack.

FIG. 3A is a perspective view of an embodiment of a roof panel for the inventive utility rack.

FIG. 3B is a perspective view of an embodiment of a side panel for the inventive utility rack.

FIG. 3C is a perspective view of an embodiment of a front or real panel for the inventive utility rack.

FIG. 4A is a perspective view of an additional embodiment of the inventive utility rack.

FIG. 4B is a perspective view of an additional embodiment of the inventive utility rack.

FIG. 5A is a cross-sectional view of a portion of an embodiment of the inventive utility rack.

FIG. 5B is a cross-sectional view of a portion of an embodiment of the inventive utility rack.

FIG. 5C is a cross-sectional view of a portion of an embodiment of the inventive utility rack.

FIG. 6A is a side view of a portion of an embodiment of the inventive utility rack.

FIG. 6B is a side view of a portion of an embodiment of the inventive utility rack.

FIG. 6C is a cross-sectional view of a portion of an embodiment of the inventive utility rack.

FIG. 7A is a side view of an embodiment of the inventive utility rack.

FIG. 7B is a side view of an additional embodiment of the inventive utility rack.

FIG. 7C is an interior side view of the embodiment of FIG. 7B.

FIG. 7D is a perspective view of a portion of the embodiment of FIG. 7B.

FIG. 8A is a perspective view of an embodiment of the inventive utility rack with full side access doors.

FIG. 8B is a cross-sectional view of a portion of the embodiment of FIG. 8A.

FIG. 8C is a perspective view of the exterior of a side access door panel of the embodiment of FIG. 8A.

FIG. 8D is a perspective view of the interior of a side access door panel of the embodiment of FIG. 8A.

FIG. 8E is a cross-sectional view of a portion of the embodiment of FIG. 8A.

FIG. 8F is a cross-sectional view of a portion of the embodiment of FIG. 8A.

FIG. 8G is a cross-sectional view of a portion of the embodiment of FIG. 8A.

FIG. 8H is a detail view of a portion of the embodiment of FIG. 8A.

FIG. 8I is a cross-sectional view of a portion of the embodiment of FIG. 8A.

FIG. 8J is a cross-sectional view of a portion of the embodiment of FIG. 8A.

FIG. 8K is a perspective view of a front panel of the embodiment of FIG. 8A.

FIG. 8L is a perspective view of a rear access door of the embodiment of FIG. 8A.

FIG. 9A is a perspective view of a top panel of the embodiment of FIG. 8A.

FIG. 9B is a cross-sectional view of a portion of a top panel of the embodiment of FIG. 8A.

FIG. 10A is a perspective view of an embodiment of the utility rack with removable panels with a rear door in a closed configuration.

FIG. 10B is a perspective view of an embodiment of the utility rack with removable panels with a rear door in an open configuration.

FIG. 10C is a perspective view of an embodiment of the utility rack with removable panels with a rear door in an over-rotated configuration.

FIG. 11A is a cross-sectional view of an embodiment of the utility rack with removable panels with a rear door in a closed configuration.

FIG. 11B is a cross-sectional view of an embodiment of the utility rack with removable panels with a rear door in an open configuration.

FIG. 11C is a cross-sectional view of an embodiment of the utility rack with removable panels with a rear door in an over-rotated configuration.

FIG. 12A is a cross-sectional view of a portion of an embodiment of the utility rack with removable panels with a rear door in a closed configuration.

FIG. 12B is a cross-sectional view of a portion of an embodiment of the utility rack with removable panels with a rear door in an open configuration.

FIG. 12C is a cross-sectional view of a portion of an embodiment of the utility rack with removable panels with a rear door in an over-rotated configuration.

FIG. 13 is a detail view of an embodiment of a disconnecting hinge of an embodiment of the utility rack with removable panels.

FIG. 14A is a perspective view of an embodiment of a disconnecting hinge in a closed configuration.

FIG. 14B is a perspective view of an embodiment of a disconnecting hinge in an open configuration.

FIG. 14C is a perspective view of an embodiment of a disconnecting hinge in an over-rotated configuration.

FIG. 15A is a cross-sectional view of an embodiment of the inventive utility rack with an alternative embodiment of a panel fastener in an unlatched position.

FIG. 15B is a cross-sectional view of an embodiment of the inventive utility rack with an alternative embodiment of a panel fastener in a latched position.

FIG. 16A is a top plan view of an alternative embodiment of a panel fastener.

FIG. 16B is a perspective view of an alternative embodiment of a panel fastener.

FIG. 16C is a perspective view of an alternative embodiment of a panel fastener.

FIG. 16D is a bottom plan view of an alternative embodiment of a panel fastener.

FIG. 16E is a side plan view of an alternative embodiment of a panel fastener.

### DETAILED DESCRIPTION

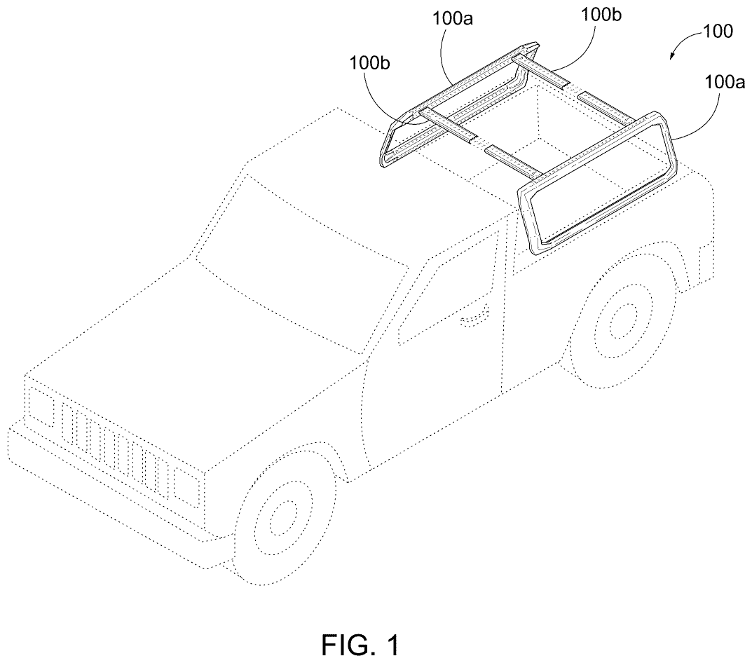

Referring now to FIG. 1, an embodiment of the inventive utility rack is shown disposed on a truck. In this depiction the embodiment is shown with the removable panels removed from the structural frame 100. In this configuration a user may reach through or around the structural frame 100 to reach items in the cargo area of the truck bed. Various items of cargo may be attached to the structural frame 100 in this configuration as further described below.

The structural frame 100 may vary in its details in different embodiments of the inventive utility rack, but in the embodiment depicted in FIG. 1 the structural frame comprises two side frames 100a and two cross members 100b. In this embodiment the side frames 100a are affixed or attached to the side walls of the truck bed at one or more points by bolts, clamps, or other means of removable attachment that are not depicted in FIG. 1.

In the embodiment depicted in FIG. 1, the side frames 100a comprise a bottom rail, a top rail, two vertical supports, and elbows to attach the rails to the supports. In other embodiments the side frames 100a may not have elbows or one or more of the rails, elbows, and supports may be bent, cast, or otherwise formed from a single piece of metal or other material. In other embodiments the top or bottom rails may extend past the vertical supports, or vice versa. In some embodiments the bottom rail is all or partially in contact with the sidewall of the truck bed, while in other embodiments it may be spaced apart from the side wall of the truck bed, either vertically, horizontally, or both.

The crossbars or cross members 100b in the depicted embodiment may be extendable to adjust to varying width of truck bed, or to extend above and over the tops of side frames 100a. In some adjustable embodiments the crossbars 100b comprise two members that slide with respect to one another to adjust the overall length of the crossbar 100b. In some of these embodiments one of the members may slide into a cavity in the other member or nest in grooves or channels in the other member. In some embodiments the crossbar 100b consist of three or more members that slide with respect to one another. In some of these embodiments a mechanism is provided to fix the members of the crossbar 100b at desired positions with respect to one another so that the overall length of the crossbar is fixed. In other embodiments the crossbar 100b may also comprise a single, fixed length member. In some embodiments the crossbar 100b is disposed above the removable roof panel 200b. In some embodiments the crossbar 100b is attached to brackets to allow it to be raised above the level of the roof panel 200b or the side frames 100.

The various components and members of the structural frame 100 may, in embodiments, include various means of mounting additional equipment on the outer or inner surfaces of the frame 100. In this context, “outer” or “outward” refers to surfaces of the structural frame 100 that are facing away or farther from the bed of the truck than adjacent components of the structural frame 100. Similarly, “inner” or “inward” refers to surfaces on the structural frame 100 that are facing toward or closer to the bed of the truck than adjacent components of the structural frame 100. “Inner” surfaces may also include the sides of the parts of the structural frame 100. Items such as ladders, canoes, kayaks, pipes, lumber, or other cargo may be placed on or mounted to the outer surfaces of the structural frame 100, especially the upward facing surfaces thereof, for transport on the truck.

Additionally, various types of racks or mounts may be affixed to the outer or inner surfaces of the structural frame 100, including, without limitation, bicycle racks, kayak racks, ski racks, spare tire mounts, traction board mounts, shovel mounts, gas or water tanks, lights, tents, cargo boxes, toolboxes, platform racks, panels with multiple attachment apertures or grids of holes, or tie down points. In some embodiments the frame 100 may have one or more t-channels along the length of one or more of the members of the frame 100 to which the various cargo or attachment devices may be affixed using bolts or similar devices with a T-head. In other embodiments, the cargo may attach with bolts in threaded or non-threaded holes in the frame 100, cam levers, or mounts that secure to members of frame 100 by encircling them with a strap, clamp, or other similar attachment mechanisms.

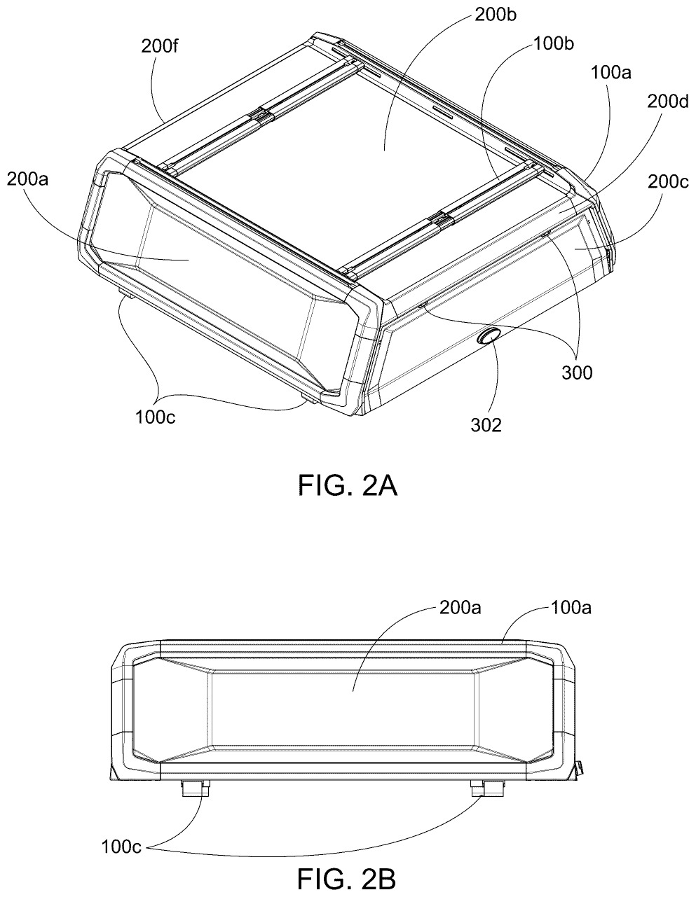

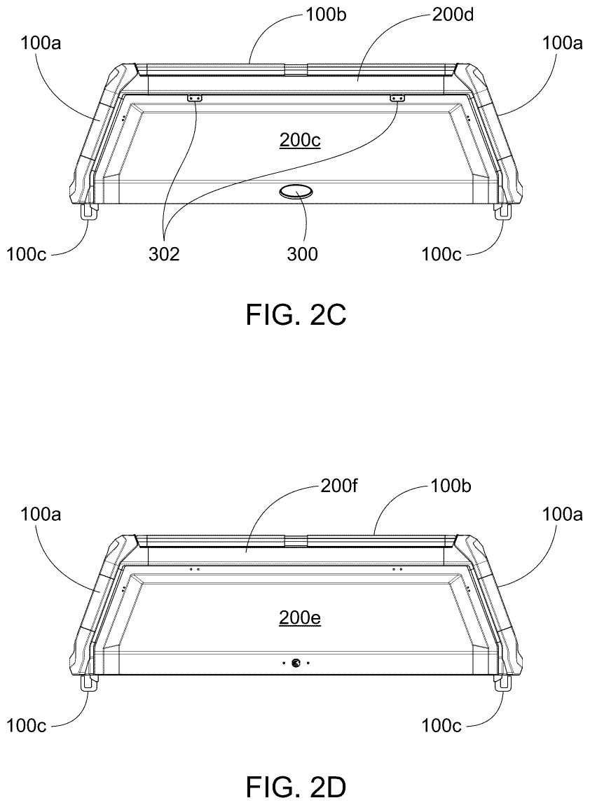

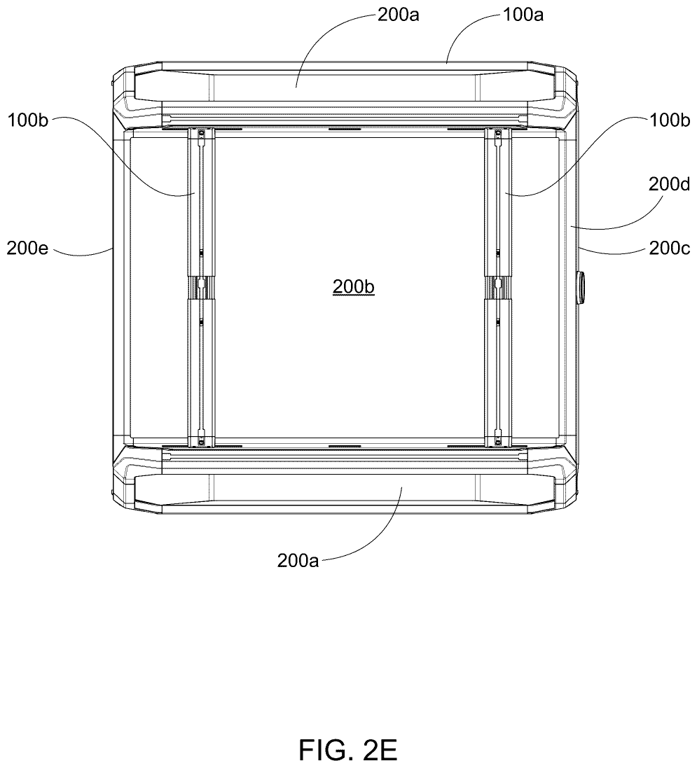

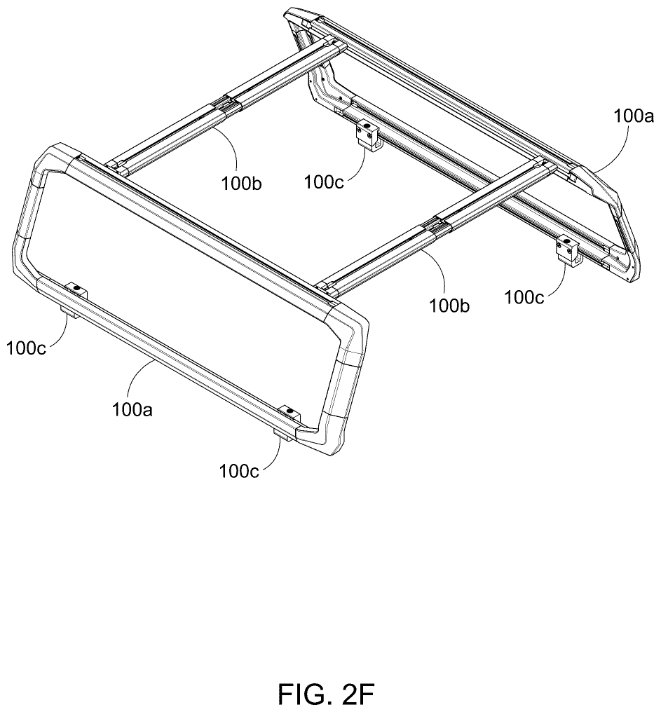

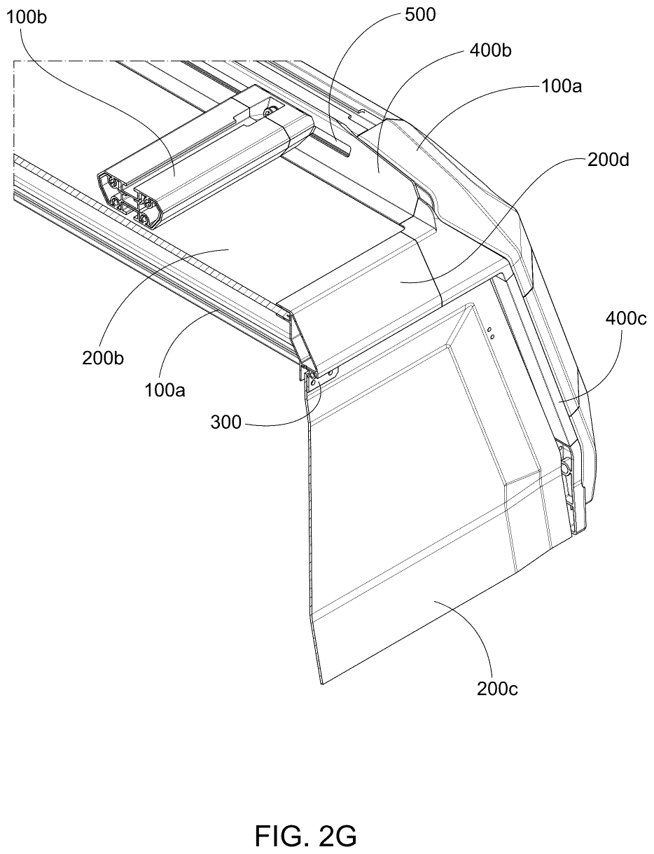

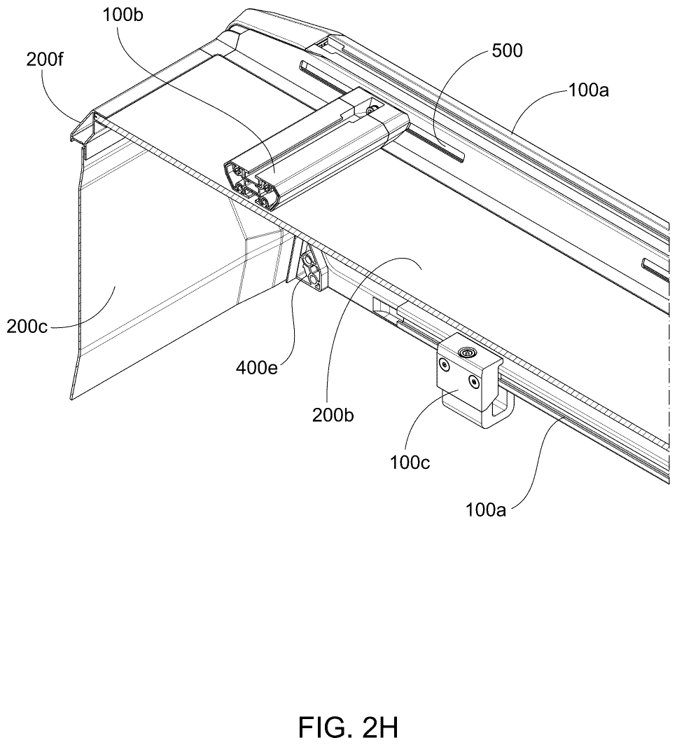

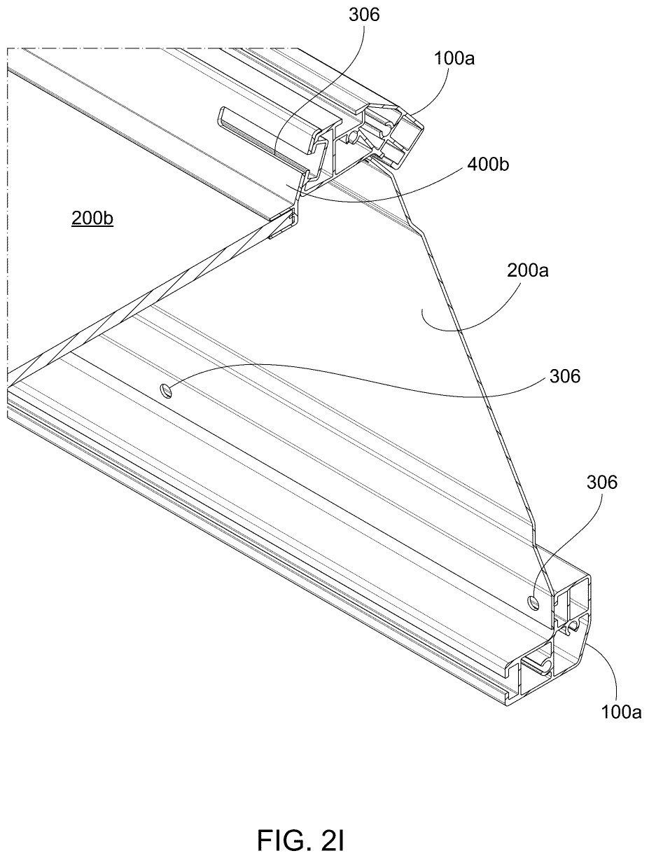

Referring now to FIGS. 2A, 2B, 2C, 2D, 2E, 2F, 2G, 2H, and 2I, various views of an embodiment of the inventive utility rack with the removable panels 200 installed are depicted. In FIGS. 2A through 2E, perspective views of embodiments of the removable panels are depicted installed on the structural frame 100. In the depicted embodiment these include two side panels 200a, top or roof panel 200b, rear panel 200c, and front panel 200e. In varying embodiments, the panels 200 may be formed from metal that is bent, stamped, or otherwise shaped to a desired configuration. In other embodiments, the panels 200 may be composite, plastic, or fabric, or be formed from a mixture of metal, plastic, composite, or fabric components.

In some embodiments each panel is independently removable from the structural frame 100, but in other embodiments one or more panels 200 may be partially or completely attached to or overlap another panel 200. For example, in the depicted embodiment rear panel 200c is attached along at least a portion of one edge to the roof panel 200b by a connector member 200d. Similarly, in the depicted embodiment the front panel 200e is attached to the roof panel 200b along its top edge by a connector member 200f. In some embodiments the panels do not have a connector member 200d or 200f but may overlap or be joined together along their adjacent edges. In other embodiments the panels 200 may overlap one another at the points of attachment to the frame 100, or they may require installation or removal from the frame 100 in a certain order.

In some embodiments the panels 200 may be attached to the frame 100 by screws, bolts, or other similar means of attachment. In some embodiments all or a portion of these attachment means are disposed on the interior surface of the panels 200 for aesthetic and security reasons. In some embodiments the means of attachment may include quick release mechanisms. Example of such quick release mechanisms include quarter-turn fasteners, quarter turn clamping fasteners, cam levers, striker-type automatic latches, or other mechanisms of similar type. In some embodiments the quick release fasteners are releasable from outside the removable panel so that a user could release the fasteners and remove a panel without getting into the truck bed. In some embodiments the removable panel may be provided with a lock component to secure it to the frame to secure it from theft. In some cases, the lock component may be incorporated into one or more of the quick release fasteners to prevent the fasteners from turning or otherwise releasing.

In various embodiments the side panels 200a may be abutted against the inside surface of the side frames 100 as shown in FIG. 2I. In other embodiments they may overlap or about an outer surface of the side frames 100 on one or more edge. In some of these embodiments, the panels 200 or the frame 100 may be provided with an interface component or seal between a panel 200 and the frame 100 or the other panels 200, or adjacent to or over the joint. These interface components may be designed to reduce water intrusion through the joint or interface into the cargo area of the truck bed. Embodiments of the interface component may comprise bulb seals, gaskets, edge trims, trim seals, lid seals, flap seals, or other types of seal or gasket components to reduce water intrusion between the two attached components.

In some embodiments of the inventive utility rack, including the depicted embodiment, the side frame 100a comprises an outer frame that extends around the top, bottom, and side edges of the side panels 200a. The outer frame may be formed from one or more pieces, but once assembled the pieces form a frame that extends continuously around the outer edge of the side panels 200a.

In varying embodiments, portions, or all of the outer surfaces of the structural frame 100 are not covered by the removable panels 200. This allows the frame 100 to be used to directly support cargo and equipment while the removable panels are in place. In some embodiments the removable panels 200 may be placed on the frame 100 without removing some or all the cargo or equipment attached to the outer surfaces of the frame 100.

Referring to FIG. 2G, a cross-sectional view of a portion of an embodiment of the inventive utility rack is depicted along a lengthwise or longitudinal axis of the embodiment of the utility rack. In this view the roof panel 200b and the rear panel 200c are shown in cross section. In this embodiment the body of panel 200b is secured in grooves in connector member 200d and bracket 400b. In this embodiment these brackets 400b form part of the roof panel 200b and provide attachment points 500 to attach the roof panel 200b to the structural frame 100. The brackets 400b may be permanently attached to the body of the panel 200b such as by glue, adhesive, screws, compression, or other means of attachment, either permanent or removable. In some embodiments the connector member 200d may be bent, extruded, or pressed metal, molded plastic, composite, or other suitable material, or may be formed unitarily with either of the panels 200b or 200c. In varying embodiments other brackets or connector members may be utilized to attach the body of the panel 200b to the frame 100, or the body of the panel may be directly attached to the structural frame 100. In the depicted embodiment a slot 500 is provided in the bracket 400b. The cross bar 100b may be bolted to the side frame 100a through the slot 500 thereby securing both the cross bar 100b and the roof panel 200b to the side frame 100a. The apertures 500 are slots in this embodiment to allow the cross bar 100b to be positioned on the side frame 100a as desired by the user.

In the depicted embodiment the connector member 200d is an extrusion that forms part of the roof panel 200b and provides support to the rear panel 200c. In other embodiments it may be bent or pressed sheet metal, angle iron, or formed as part of the body of panel 200b or 200c. In this embodiment the rear panel 200c is attached to the connector member 200d by one or more hinges 300 so that the rear panel 200c may be raised and lowered as a door to access the cargo area of the truck bed. In some embodiments, adapter pieces 400c may be provided on each side of the rear panel 200c to fill any gap between the panel 200c and the structural frame 100 or other adjacent panel 200. The adapter pieces may also serve as parts of a latch mechanism like those provided on rear access doors in truck caps. In other embodiments of the utility rack, the side panels 200a may also have access doors that cover all or a portion of each of them.

In some embodiments, all or a portion of one or more of the edges of the panels 200 may fit into a groove or channel in the structural frame 100 or another panel 200. The edge of the panel may be provided with complete or partial edge trim to provide water resistance to the joint. In some embodiments brackets or adapters 400 may be provided to connect the panels to the frame 100. In the depicted embodiment the panels lap over portions of the structural frame 100.

Referring now to FIG. 2H, a cross-sectional view of a portion of an embodiment of the inventive utility rack is depicted along a lengthwise or longitudinal axis of the embodiment of the utility rack. In this view the roof panel 200b and the front panel 200e are shown in cross section. Similar to the attachment of the rear panel 200c to the roof panel 200b, the front panel 200e is attached to the body of roof panel 200b by a connector member 200f. The connector member 200f is depicted as an extrusion with grooves or flanges for attaching to the body of panels 200b and 200e, but in other embodiments the connector member 200f may be bent or pressed metal, plastic, composite or other suitable material, or may be formed unitarily with either of the panels 200b or 200e, or have other embodiments as described in relation to connector member 200d.

Referring now to FIG. 2I, a cross-sectional view of a portion of an embodiment of the inventive utility rack is depicted along a widthwise or transverse axis of the embodiment of the utility rack. In the embodiment depicted in this figure, the side panel 200a is configured to directly attach to the upper and lower rails of side frame 100a at apertures 306. The upper edge may be inserted into a groove or channel in the side frame extrusion for 100a. For this embodiment a bolt may be positioned with its head in the t-channel in the side frame extrusions and a nut then secured through the aperture 306 to hold the panel 200a in place, or vice versa with respect to the nut and bolt. In other embodiments, the side frame extrusions may have tapped holes to receive bolts, self-tapping screws, or other similar fastening mechanisms may be used to attach the panel 200a to the side frame 100a.

In the depicted embodiment all four main edges of the panel 200a overlap the interior or inner surfaces of the structural frame 100. In other embodiments, one edge of the panel 200a may fit into a groove or channel in the side frame 100a, while the other three edges all or partially overlap a portion of the side frame. This configuration allows the panel to be attached by holding it at an angle with respect to the structural frame 100a, inserting the first edge of the panel 200a into the channel in the frame 100a, rotating the panel 100a to bring the other three edges of the panel 200 into contact with the structural frame 100, and then operating one or more actuators to secure the panel against the structural framework.

In some embodiments the panel 200a may be attached and detached from the side frame 100a from the inside or outside of the utility rack. In other embodiments, the edges of the panel 200a may overlap or contact outer or upper surfaces of the side frame 100 or of the components of the side frame 100. In some embodiments the panels may have apertures or other mounting points to attach equipment or other cargo to the panels 200 themselves. In varying embodiments any rear or side access doors may be removed from the panels by releasing any hinge mechanisms and disconnecting any spring opening mechanisms on the doors.

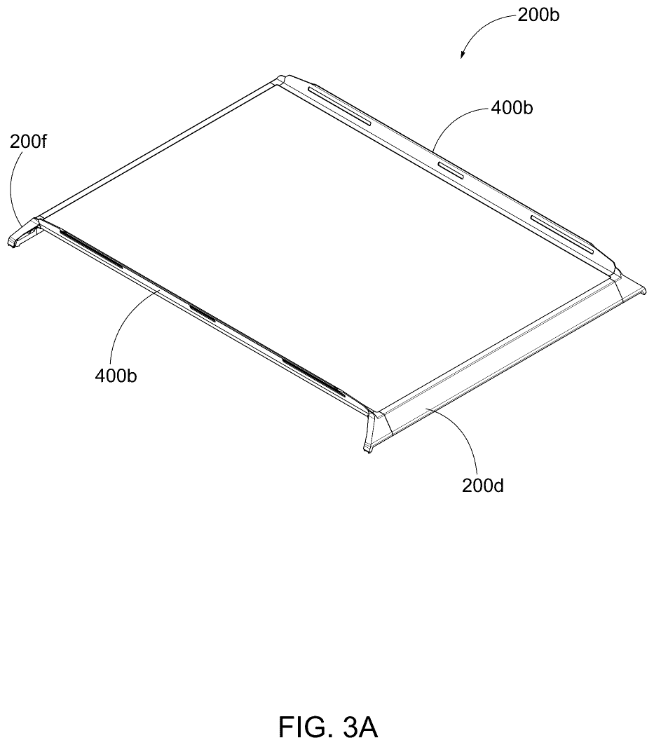

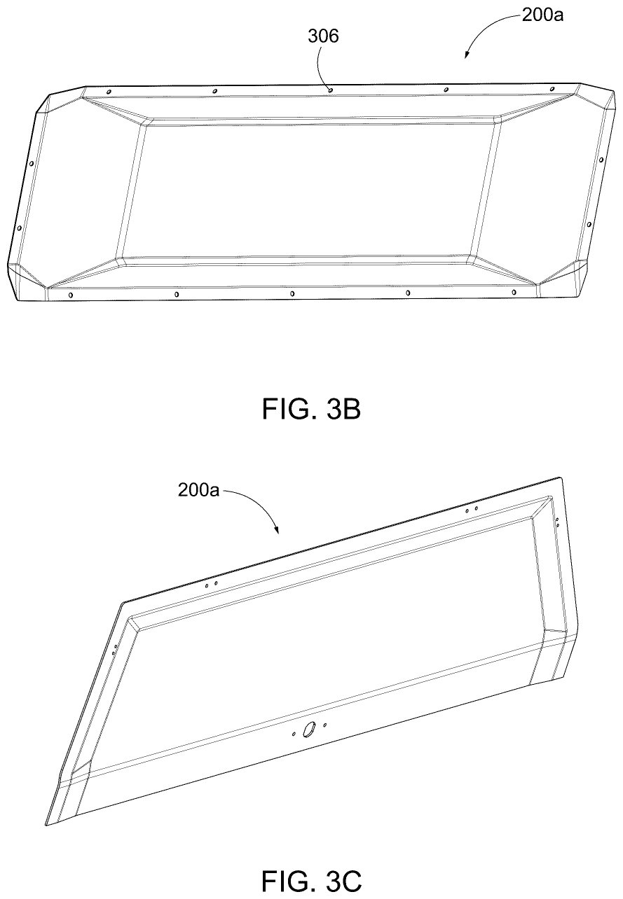

FIG. 3A depicts an embodiment of the roof panel removed from the frame 100. This embodiment has a main surface with brackets 200d, 200f, and 400b attached to its edges to provide attachment points for the side frames 100 and front and rear panels as described above. Similarly, FIGS. 3B and 3C depict embodiments of the side panel 200a and rear panel 200c after removal from the frame 100.

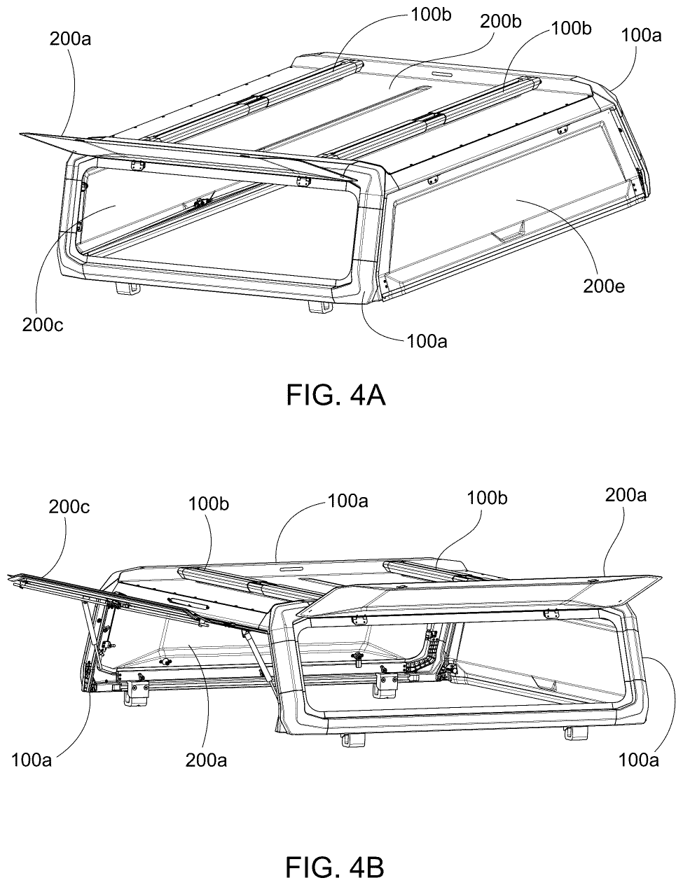

Referring now to FIGS. 4A and 4B, perspective views of an additional embodiment of the utility rack are depicted. In this embodiment the side panels 200a are attached to the side frames 100a by hinges 300. The entire side panel 200a in this embodiment comprises an access door that may be opened from the outside of the truck cargo bed to allow access to the interior of the cargo bed. In some embodiments the side panels 200a are all or partially made of glass or other similar transparent material.

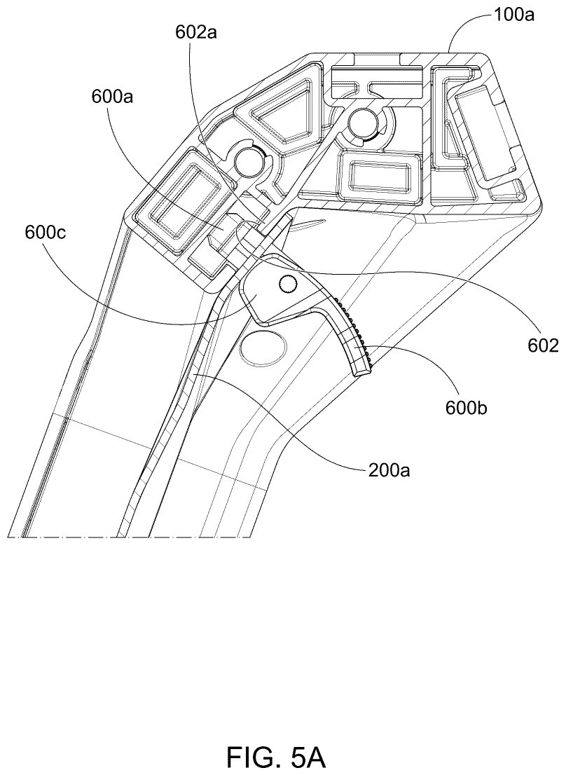

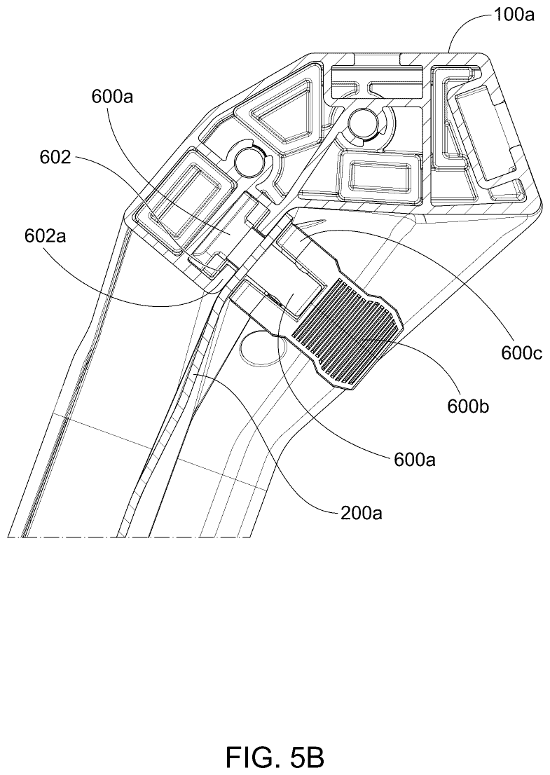

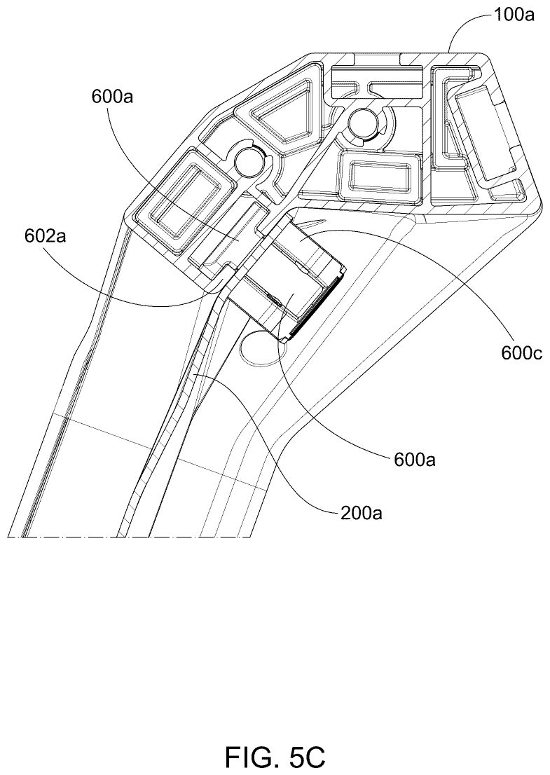

FIGS. 5A, 5B, and 5C depict an embodiment of side panel 200a with quarter turn fasteners 600 on the inside surface of the panel 200a. The quarter turn fasteners allow the panel 200a to be quickly and securely attached to and removed from the frame 100. In the depicted embodiment, the quarter turn fasteners 600 engage a t-channel 602 provided on an inner surface of the side frame 100a. The t-bolt 600a may be inserted into or removed from the t-channel when it is in the position shown in FIG. 5A. Upon insertion, the lever 600b may be rotated in a first axis to the position shown in FIG. 5B, thus rotating the t-bolt as shown so that it may not be removed from the t-channel. Then the lever 600b may be rotated in a second axis to the position shown in FIG. 5C. Rotation of the lever 600b around the second axis translates the t-bolt 600a due to the shape of cam body 600c as shown in FIG. 5A. This translation pulls the t-bolt 600a toward the side panel 200a thus squeezing the flanges of the t-channel between the t-bolt 600a and the side panel 200a. This engagement and the shape of the t-bold 600a hold the panel 200a in place. The fastener 600 may be released and removed by reversing the order of these steps.

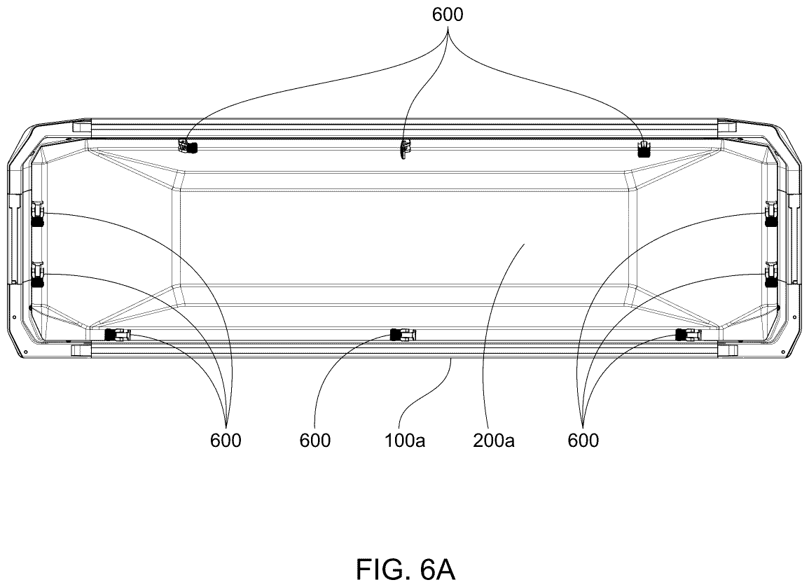

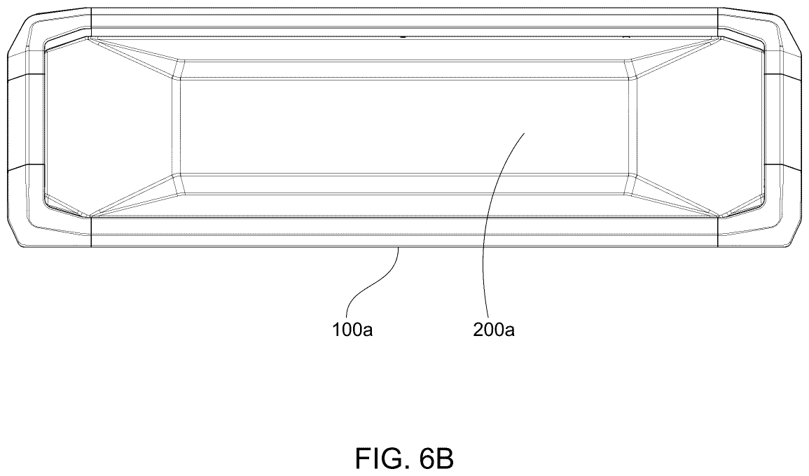

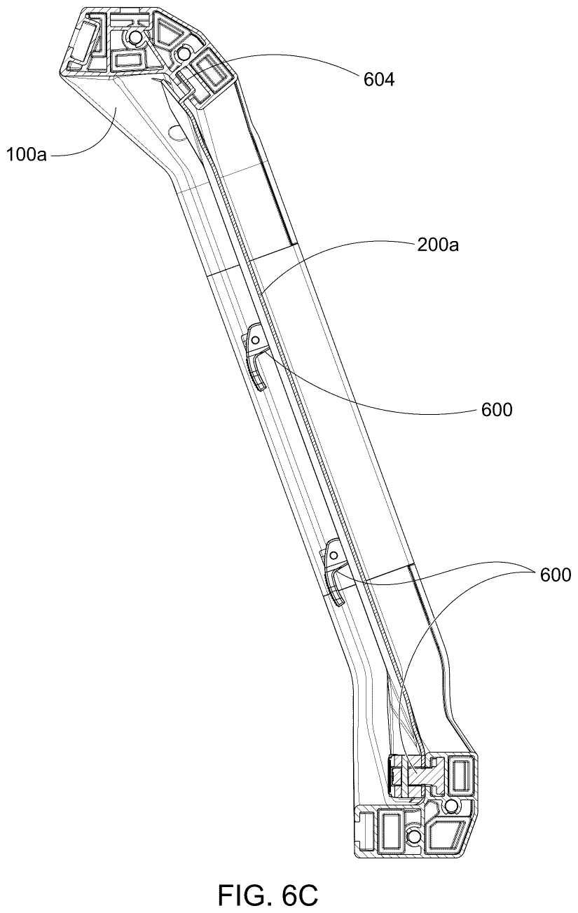

FIG. 6A depicts the inside surface of a side frame 100a with a side panel 200a attached to it. In this embodiment the side panel 200a is attached to the side frame 100a by a number of quarter turn fasteners 600. In other embodiments some or all of these fasteners 600 may be replaced with other types of fasteners described above. FIG. 6B depicts the outer surface of the partial embodiment shown if FIG. 6A. In FIG. 6B the fasteners are not visible and the frame and panel are secure from intrusion into the cargo bed when incorporated into the full rack with other panels. FIG. 6C depicts a cross-sectional view of an embodiment where the quarter turn fasteners 600 on the top edge of panel 200a have been replaced with a flange 604 that directly engages t-channel 206 on the upper part of side frame 100a.

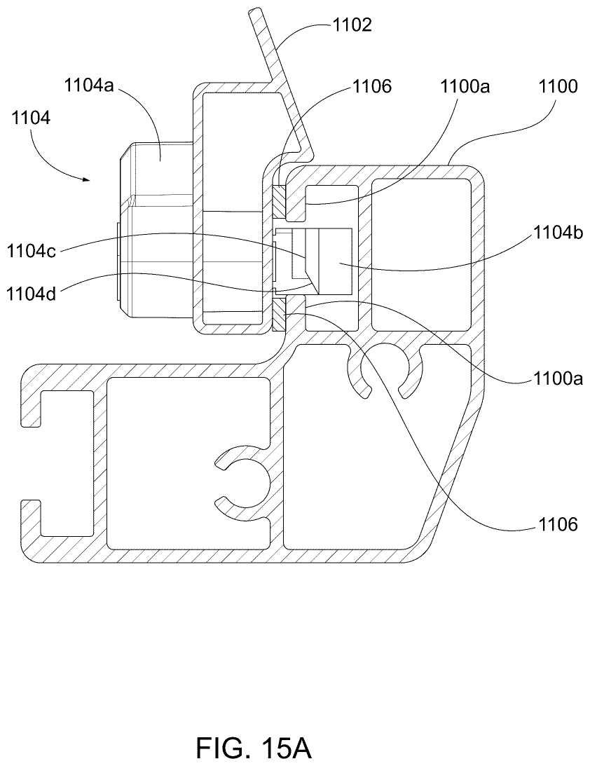

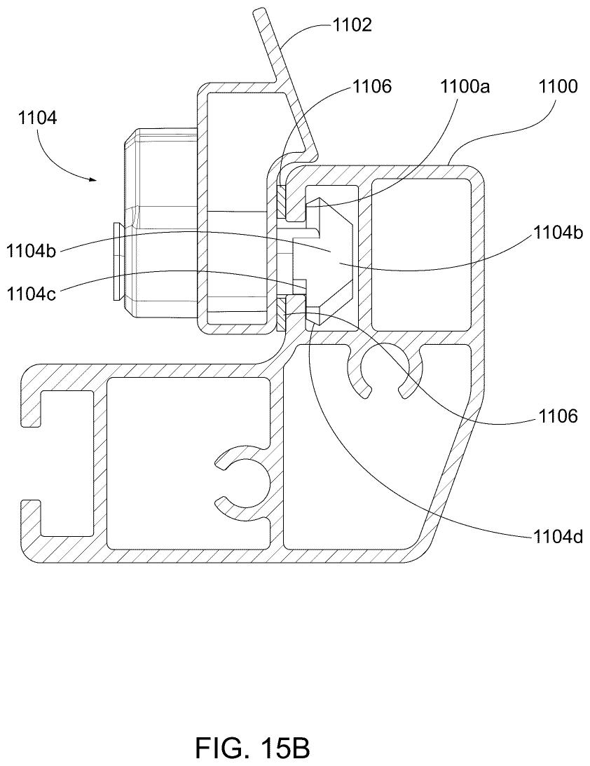

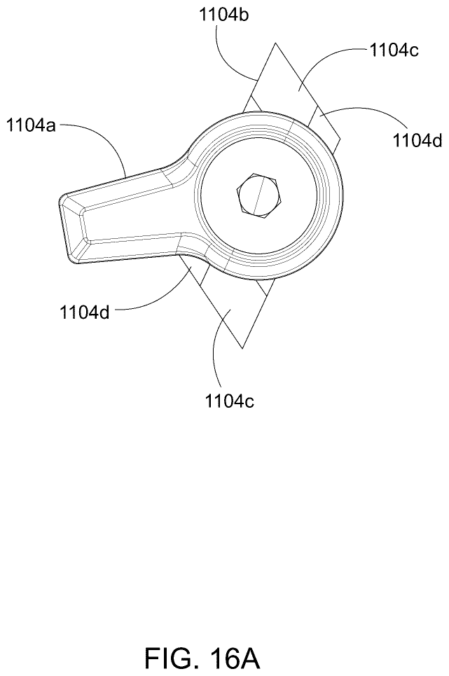

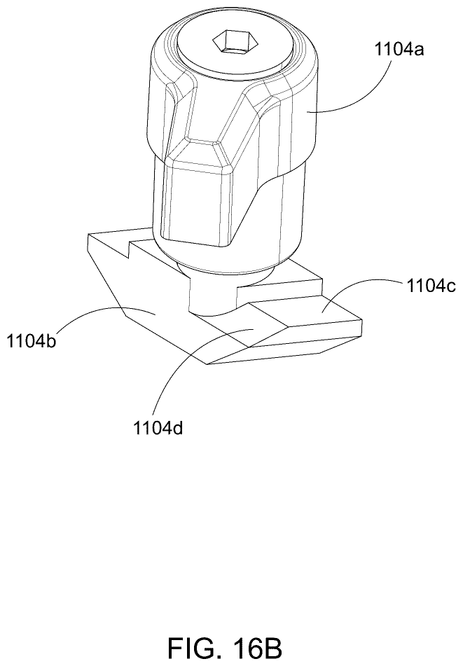

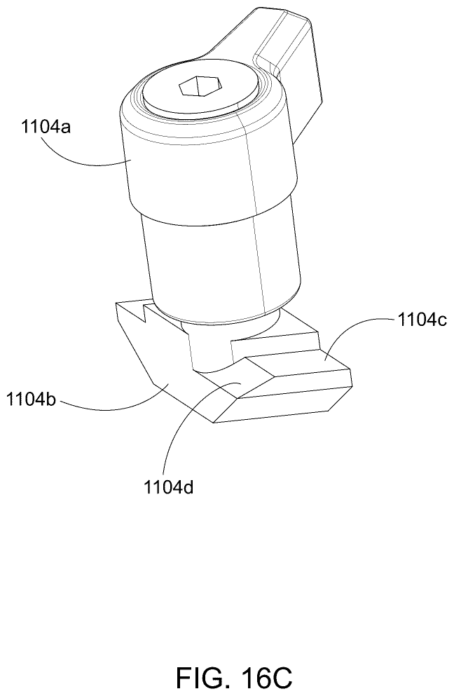

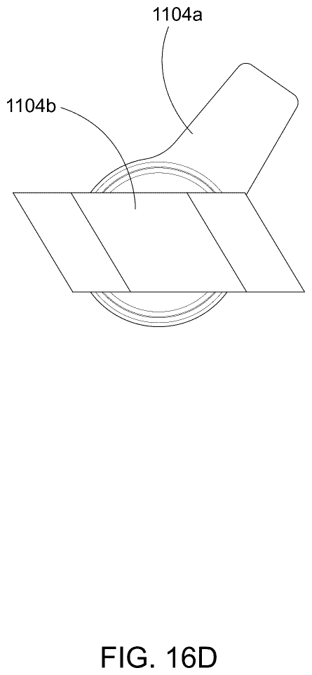

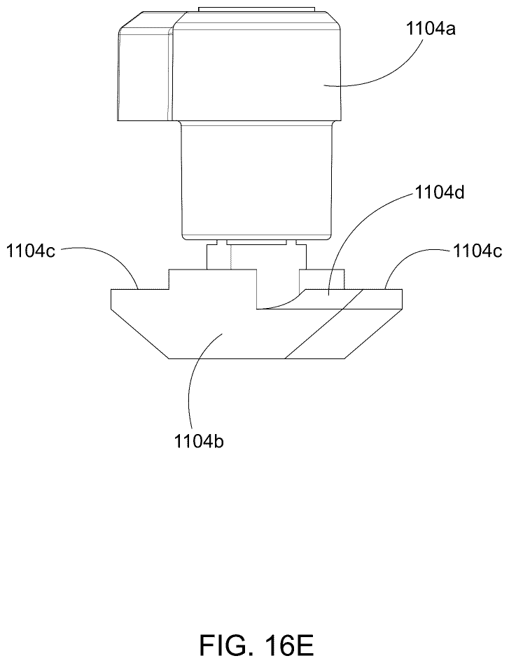

In some embodiments the quarter turn fasteners may be the embodiment depicted in FIGS. 15A through 16F, inclusive. The embodiment of fastener 1104 also latches and unlatches with a quarter turn revolution and does not require the step of folding a lever over to pull the latch tight as the prior embodiment requires. In this embodiment the fastener 1104 has a wedge or angled surface 1104d that pulls the fastener tight as it is revolved through a quarter turn revolution.

FIG. 15A depicts a cross-sectional view similar in concept to FIG. 5A, a fastener 1104 being used to attach a panel 1102 to the frame 1100 of a utility rack. In the depiction of 15A, the handle 1104a of the fastener is on the inside of the panel 1102, and the fastener extends through a hole in the panel 1102 to the t-nut 1104b disposed near the outer surface of the panel 1102. The depicted configuration of the quarter turn fastener t-nut 1104b is in an unlatched position after insertion into a t-channel on the rack. The width of the t-nut is narrow enough to fit through the cap in the t-channel. In some embodiments, one or more seals or gaskets 1106 may be provided between the panel 1102 and the rack frame 1100.

In this embodiment the handle 1104a is fixed to the t-nut 1104b so that a quarter turn of the handle 1104a will turn the t-nut 1104b to the latched position shown in FIG. 15B. As can be seen in FIG. 15A the surface 1104c of the t-nut 1104b is not completely inside the inner surfaces 1100a of the t-channel flanges, but the lower end of wedge surface 1104d is inside those inner surfaces. As the t-nut 1104b is turned by the handle 1104b, the wedge surfaces contact the flanges of the t-channel and pull the handle 1104a toward the t-channel. The handle 1104a (or another component of the fastener 1104) applies pressure on the panel 1102 and pulls it against the frame 1100. In embodiments with seals 1106, the pressure on the panel 1102 may compress the seals as shown in FIG. 15B. As the t-nut continues to turn through a quarter revolution, the wedge surface 1104d pulls inwardly on the flanges until surface 1104c of the t-nut is against inner surfaces 1100a of the t-channel flanges. This is the latched position shown in FIG. 15B.

FIGS. 16A through 16E, inclusive, depict an embodiment of this quarter turn fastener removed from the panel 1102. The figures depict top plan, front perspective, back perspective, bottom plan, and side plan views, respectively. In this embodiment the handle 1104a is connected to the t-nut 1104b by a shaft which may have a bushing to support the fastener in an aperture in the panel 1102. The t-nut may have angled ends (or angled or curved lips on the shaft) to engage the side walls of the t-channel when the fastener 1104 has turned to the correct latched position and to prevent over-rotation. In some embodiments, the surface 1104d may be curved or partially curved instead of being a simple, planar angled surface.

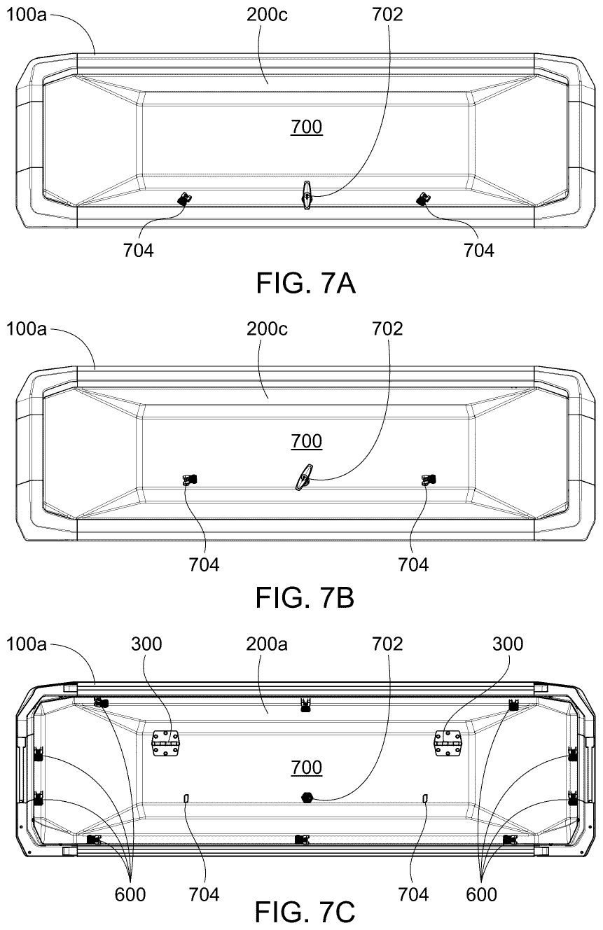

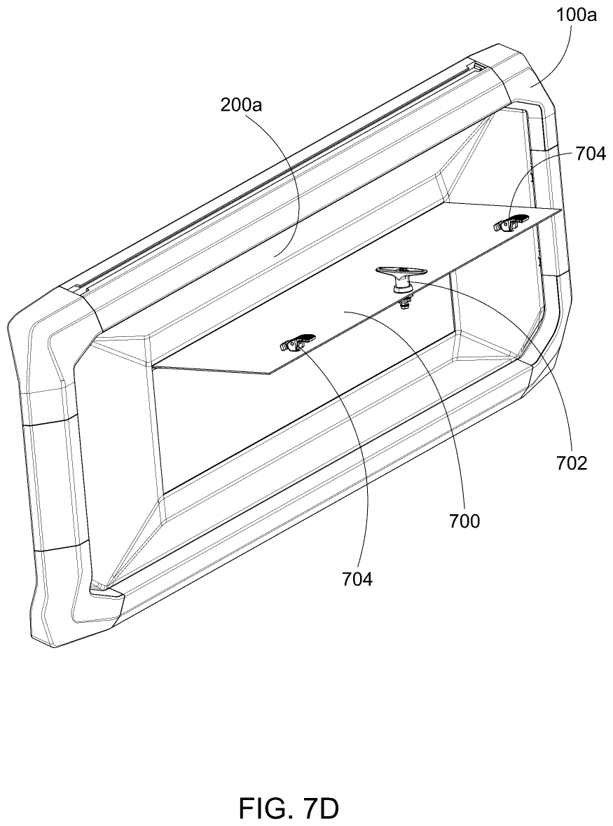

Referring now to FIGS. 7A through 7D, in some embodiments an access door may be provided in one or both of the side panels 200a. In some of these embodiments the door may be a top or side hinged door with a latch and an optional lock. The access door provides quick access to the cargo area of the truck bed without complete removal of the side panel 100a. FIG. 7A depicts side view of an embodiment of the utility rack where the entire side panel 200a is an access door similar to the embodiment depicted in FIGS. 4A and 4B. It is provided with an external latch handle 702 and externally operated quick release fasteners to provide additional holding force to keep the access door 700 closed.

FIGS. 7B, 7C, and 7D depict external side view, internal side view, and perspective view, respectively, of an embodiment of the utility rack with a side panel 200a having a partial access door 700. Like the embodiment depicted in FIG. 7A the door 700 is provided with a latch handle 702 and optional additional quick release fasteners 704. The interior view shows hinges 300 on the inside of side panel 200a. FIG. 7D depicts the side door 700 in an open position.

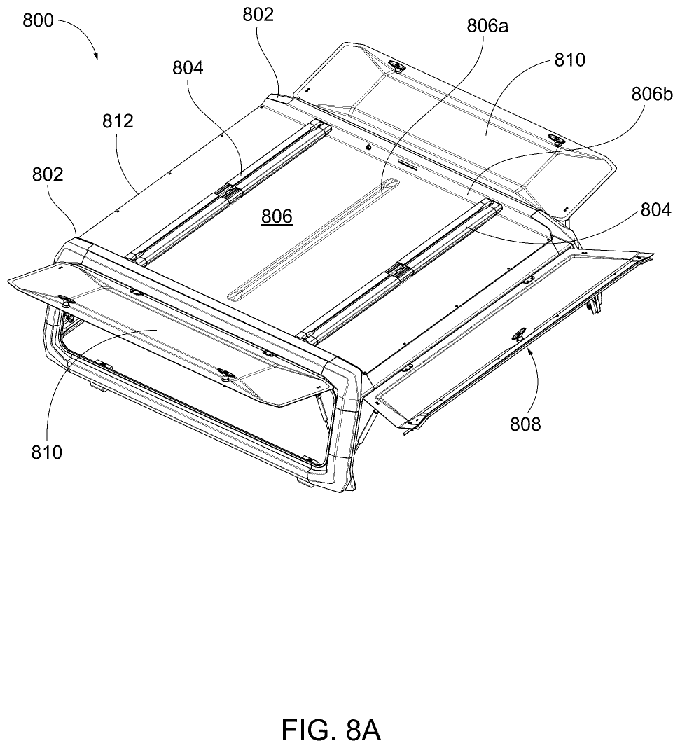

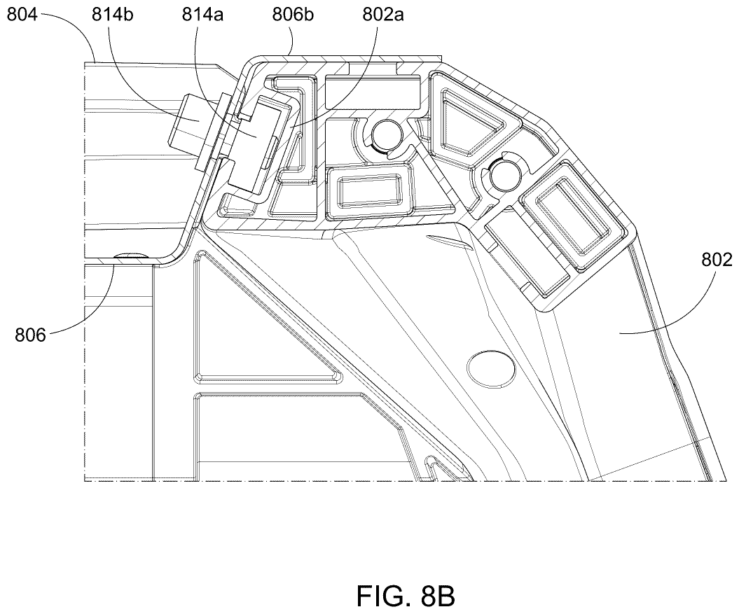

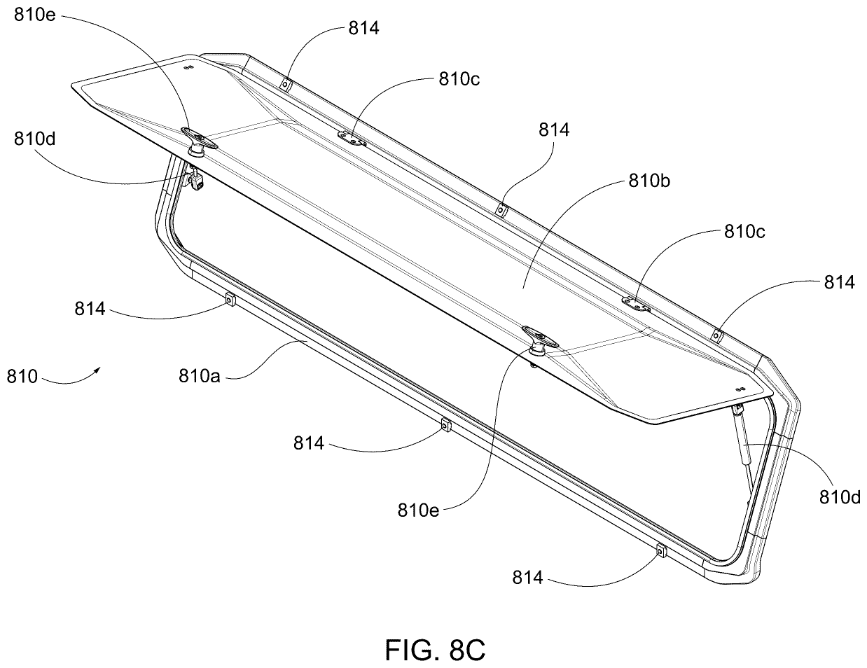

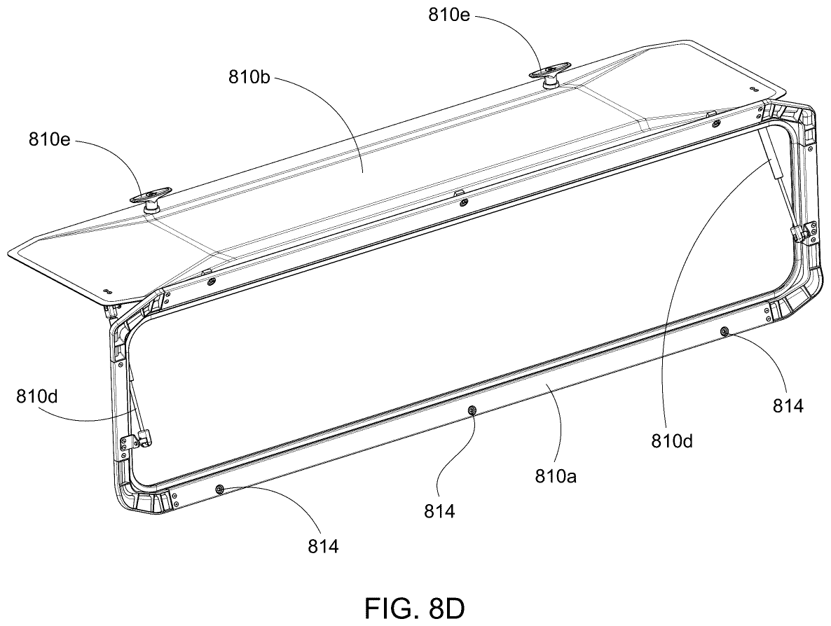

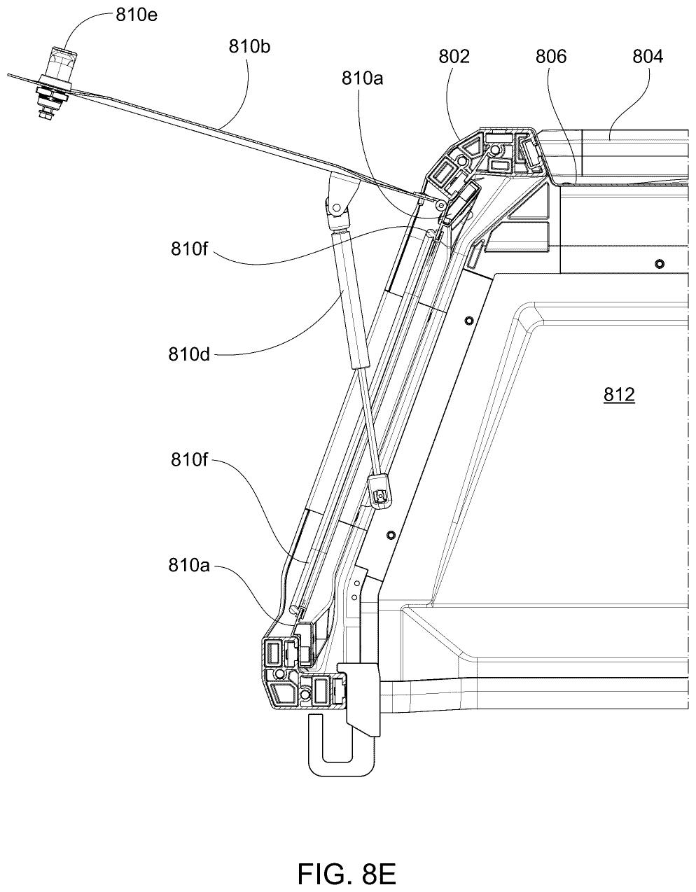

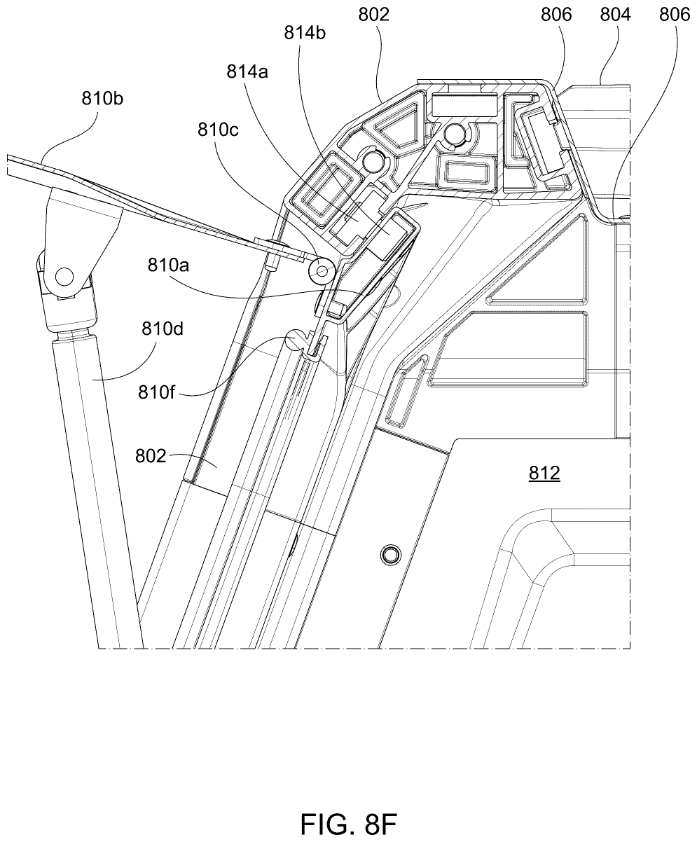

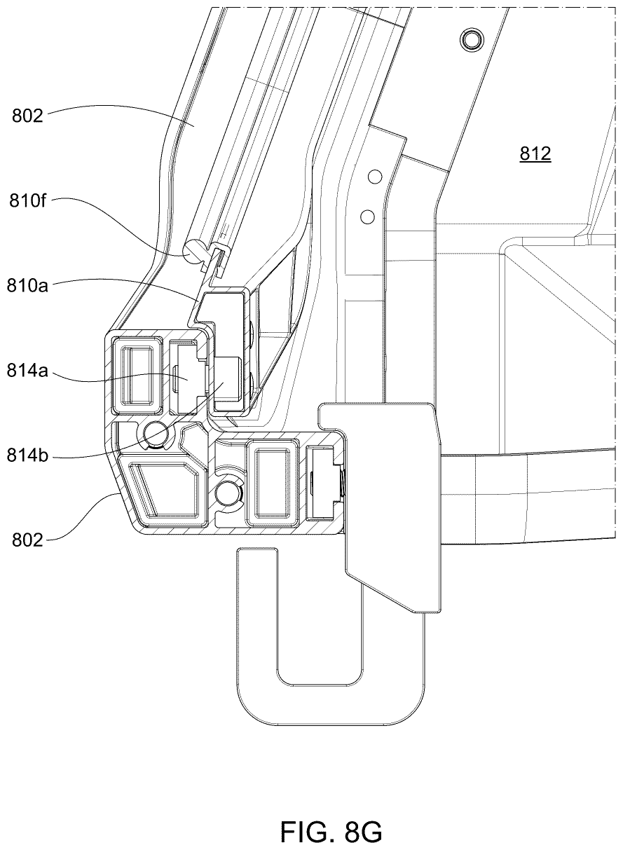

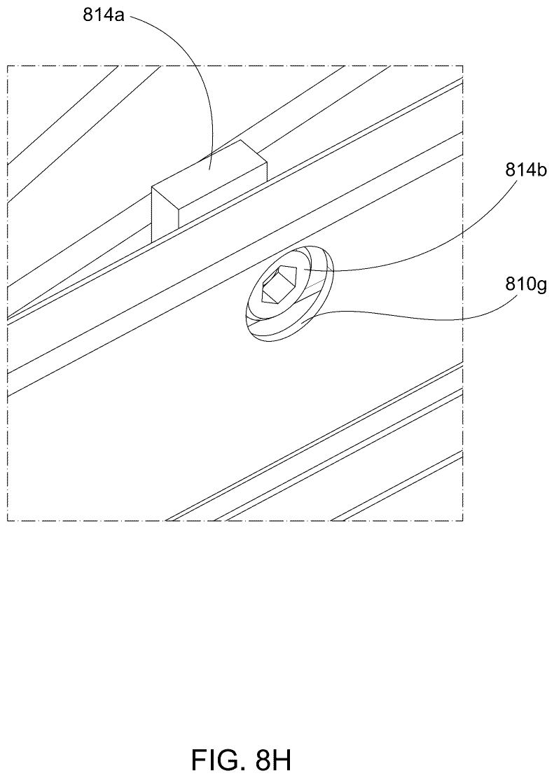

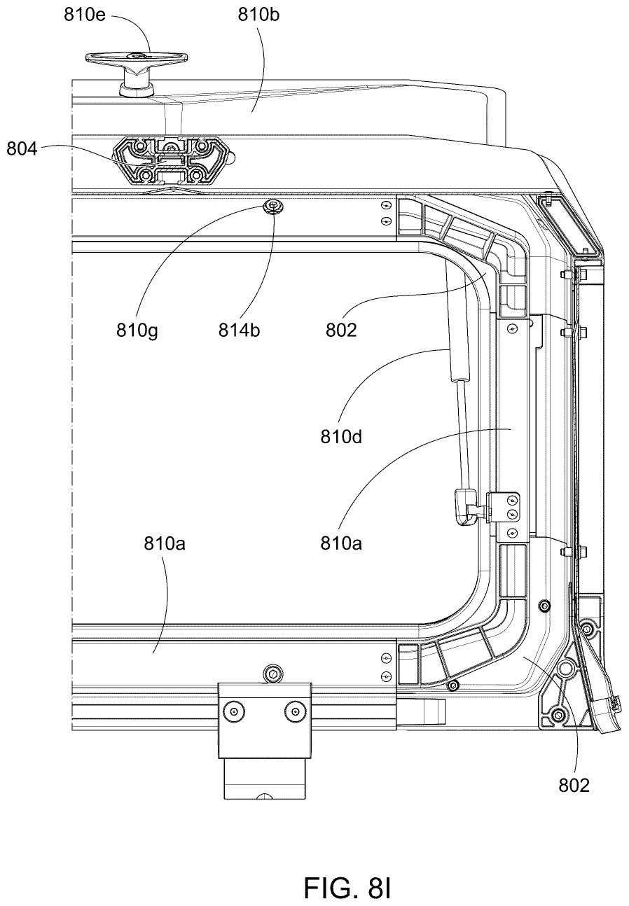

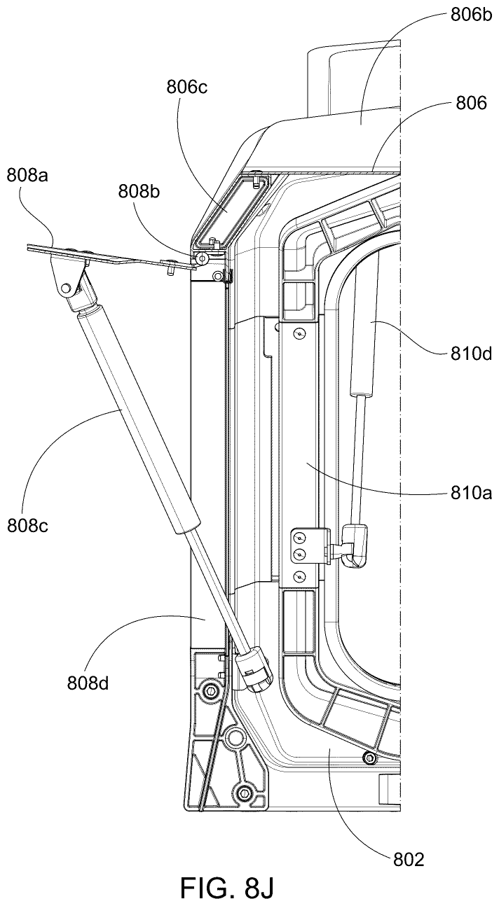

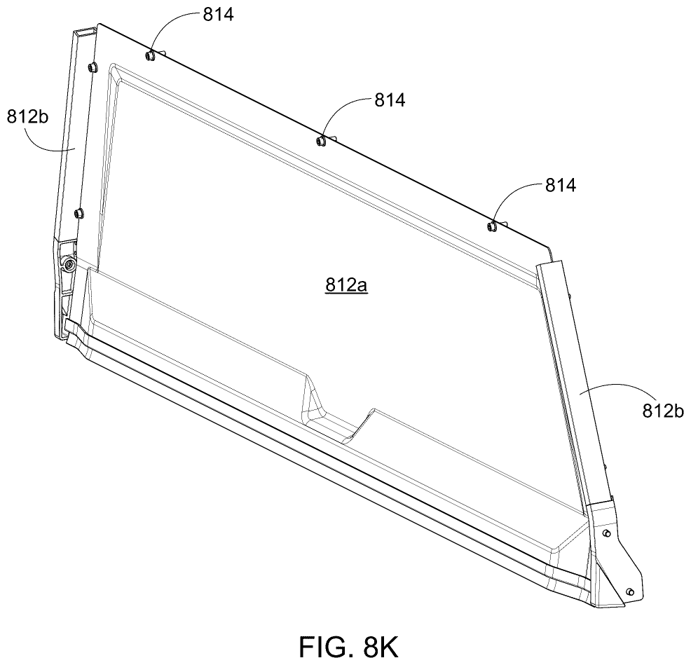

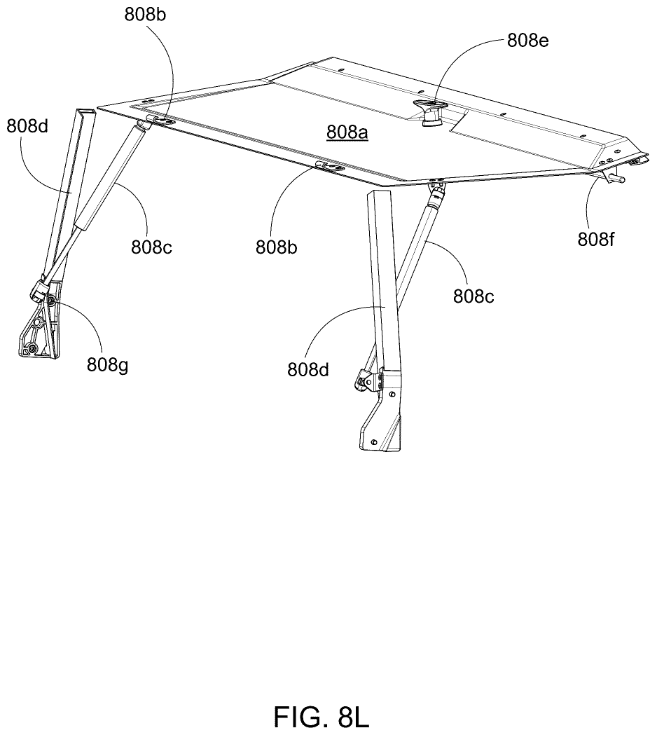

FIGS. 8A through 8L, inclusive, depict an additional embodiment of the inventive utility rack with removable panels. FIG. 8A depicts the embodiment of the utility rack 800 in a perspective view with both side access doors and rear access door in open positions. In this embodiment the side frames 802 and crossbars 804 support a roof panel 806 that has one or more reinforcing or strengthening features 806a. These features or ribs 806a provide additional strength to the top member 806 to prevent undesired flexing or bending of the top member 806. In some embodiments the features 806a may be facets or folds in the material forming the field of top member 806 or they may be separate ribs or members attached to top member 806 by bolting, welding, or other means of attachment. In some embodiments the features 806a may be provided instead of the crossbars 804. In some embodiments the features 806a end before the edge of the top member 806 or before contacting the side frame 802. In some embodiments the features 806a extend laterally across the entire width of the top member 806 or sufficiently across its width to contact side frames 802. In some embodiments the features 806a may be some or all of the points of attachment of the top member 806 to the side frames 802.

FIG. 8B depicts a detailed cross-sectional view of the joint between the top member 806 and the side frame 802 in an embodiment. In this embodiment there is not a side bracket that is formed separately for attachment to the top member 806. Instead, the edges of the sheet forming 806 are bent or folded to form side features 806b for mating the top 806 to the side frame 802. In the depicted embodiment the edges of sheet 806 have been bent upwardly and the back horizontally to overlap a portion of the top surface of side frame 802. Other embodiments may overlap more or less of frame 802, pass beneath it or insert into or through it. In this embodiment, a version of a t-channel fastener 814 is depicted attaching the top member 806 to a t-channel 802a. The t-channel fastener comprises a t-nut 814a and a t-bolt 814b.

FIGS. 8C and 8D depict exterior and interior perspective views of an embodiment of a side panel 810 for the utility rack. This side panel 810 comprises an almost full area access door 810b attached to the side frames 802 by a frame 810a. FIG. 8E depicts a cross-sectional view of a side access panel 810 also in an open position looking forward toward front panel 812. FIG. 8F is a close-up cross-sectional view of the upper edge joint between side frame 802, side panel frame 810a, and side access door 810b. FIG. 8G is a close-up cross-sectional view of the lower edge joint between side frame 810a and side frame 802.

The frame 810 may attach, as shown in this embodiment, by a plurality of t-channel fasteners 814 or other fasteners and may be provided with a seal or gasket 810f to reduce water intrusion between the door 810b and the frame 810a, or the frame 810a and the side frame 802. The frame 810a may be formed from one or multiple pieces of metal, plastics, composites, or other suitable materials. In some embodiments the side access door 810b is attached to the frame 810a by one or more hinges 810c so that it can open and close against the frame 810a. The side panel 810 may be provided with one or more lift assist or lower assist mechanisms 810d, such as gas struts or spring mechanisms. Some embodiments may be provided with latches 810e that are configured to engage the side frame 810a to latch or lock the door 810b in the closed configuration against the frame 810a.

FIG. 8H depicts an embodiment of the aperture 812g that provides access to the head of bolt 814g. This allows a user to tighten or loosen the fastener 814 as needed to add or remove a panel from the utility rack.

FIG. 8I depicts a cross-sectional view of an embodiment of the utility rack at its front panel 812 looking toward one of the side panels 810. The front panel 812 in this embodiment comprises a sheet attached to the side frames 802 and the top member 806. A connector 812b is attached to the main panel sheet 812a to connect it to the top member 806.

FIG. 8J depicts a cross-sectional view through the rear access door section of an embodiment of the utility rack. Like the front panel, the rear access door panel in this embodiment has a connector member 806c to attach it to the top panel 806. This embodiment of the connector 806c provides support for the rear access door 808a via hinges 808b. Optional lift or lower assist device 808c may be a gas strut, spring mechanism, or other similar telescoping or extending mechanism.

FIG. 8K depicts a front panel assembly 812 that has been removed from the utility rack. It is provided with a plurality of fasteners 814, and has two side frames 812b to mate the field of the panel 812a with the side frames 802. FIG. 8L depicts a rear access door assembly 808 that has been removed from the utility rack. It also is provided with side frames 808d for mating to the side frames 802. An embodiment of a latch 808e with latch rods 808f that insert into apertures 808g in the side frames 808d is depicted.

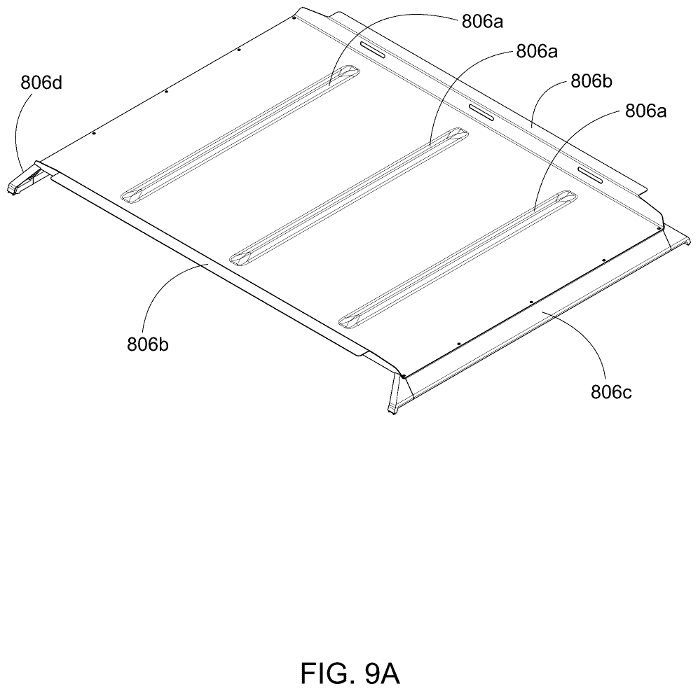

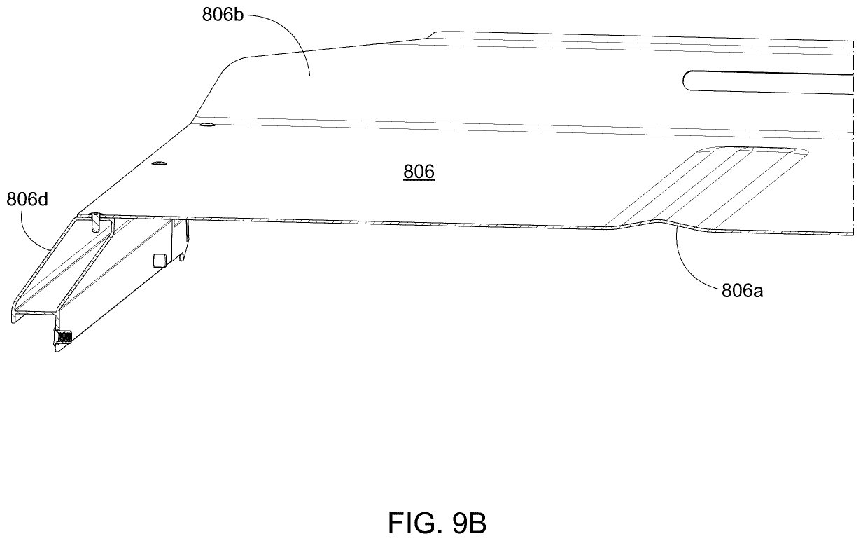

Referring now to FIGS. 9A and 9B, a perspective view and a partial cross-sectional view, respectively, of the top panel 806 is depicted. The depicted embodiment has three stiffening features 806a, one of which is shown in cross-section in FIG. 9B. The bent edges 806b and connector members 806c and 806d provide attachment points for the side frames 802 and front and rear panel assemblies.

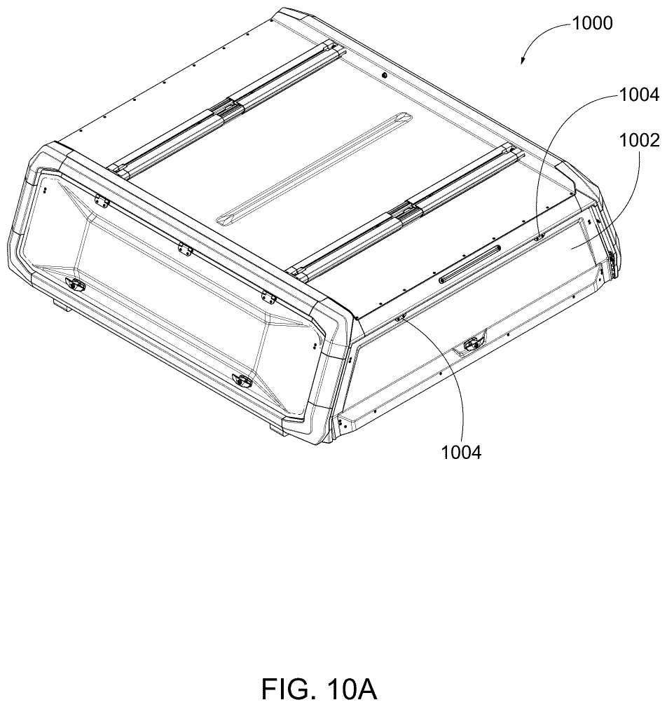

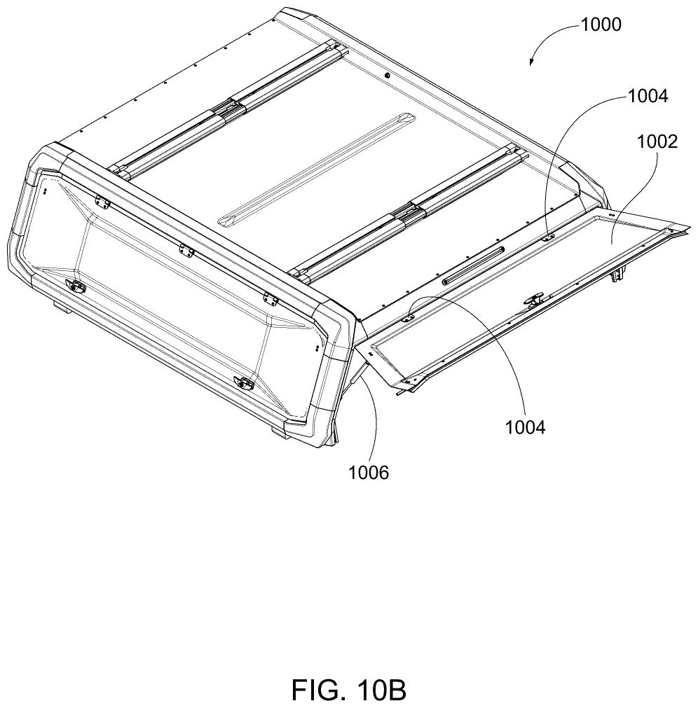

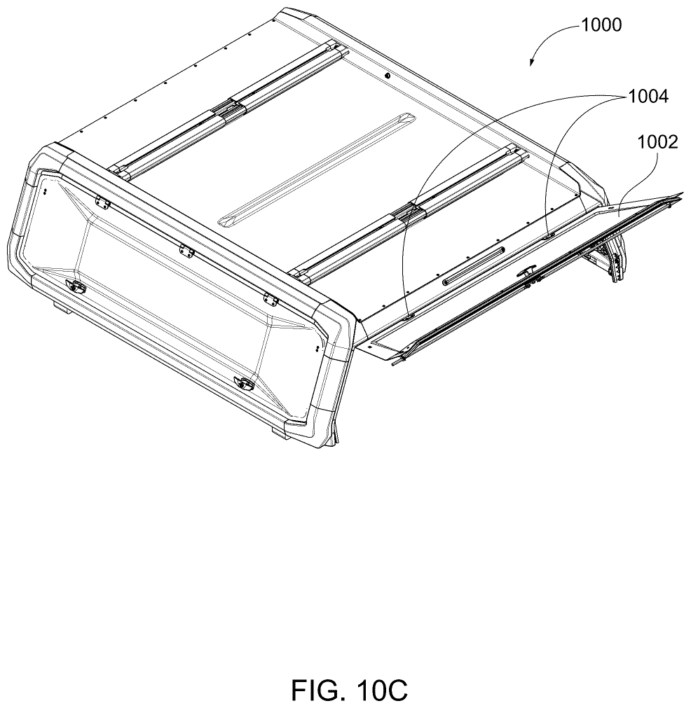

Referring now to FIGS. 10A, 10B, and 10C, an embodiment of the utility rack 1000 with removable panels is depicted with an access door 1002 that may be quickly removed without using tools or removing fasteners or other attachments. FIG. 10A depicts the access door 1002 in a closed configuration. In the closed configuration the door 1002 may be latched or locked by a handle and secured in place. During normal use the door 1002 opens on hinges 1004 to the open configuration depicted in FIG. 10B and remains connected to the rack 1000. In the depicted embodiment the door 1002 may be held open by a support 1006 such as the depicted gas struts, though in other embodiments these may be replaced with other types of extending rods, fixed length rods, or no support may be provided at all.

If a user desires to remove the access door 1002 it is desirable to do so without needing tools and to be able to remove and reattach the door 1002 in a short period of time. In some embodiments of the inventive device, the user can rotate the door 1002 past the open position of FIG. 10B to the over-rotated position shown in FIG. 10C. In some embodiments with a support 1006, the user may disconnect one or both ends of the support 1006 from the door 1004 or the rack 1000 before pivoting the door 1002 to the over-rotated position. In some embodiments the support 1006 may extend to allow over-rotation while still connected to both the door 1002 and the utility rack 1000. In varying embodiments of the inventive rack, once in the over-rotated position the hinges 1004 separate into two pieces so that the door 1002 may be removed from the rack 1000. In some embodiments the door 1002 may be translated away from the rack 1000 while in the over-rotated position to disconnect the door from the rack.

In preferred embodiments the removable door 1002 is only removable when it is in the over-rotated position to prevent unauthorized access to the cargo area of the truck. This allows a user to place personal property in the cargo bed of the truck and secure the door 1002 in the closed position, such as via a commonly used latch or lock for camper shell or truck topper doors. In some embodiments of the inventive rack 1000, the door 1002 is attached to the rack 1000 with disconnecting hinges 1004 to facilitate detaching and attaching the door 1002 to the rack 1000.

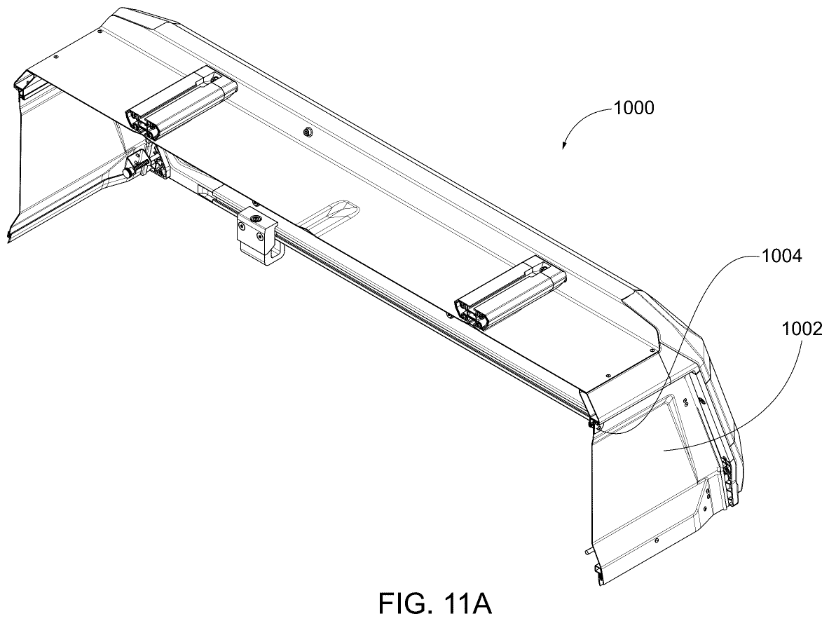

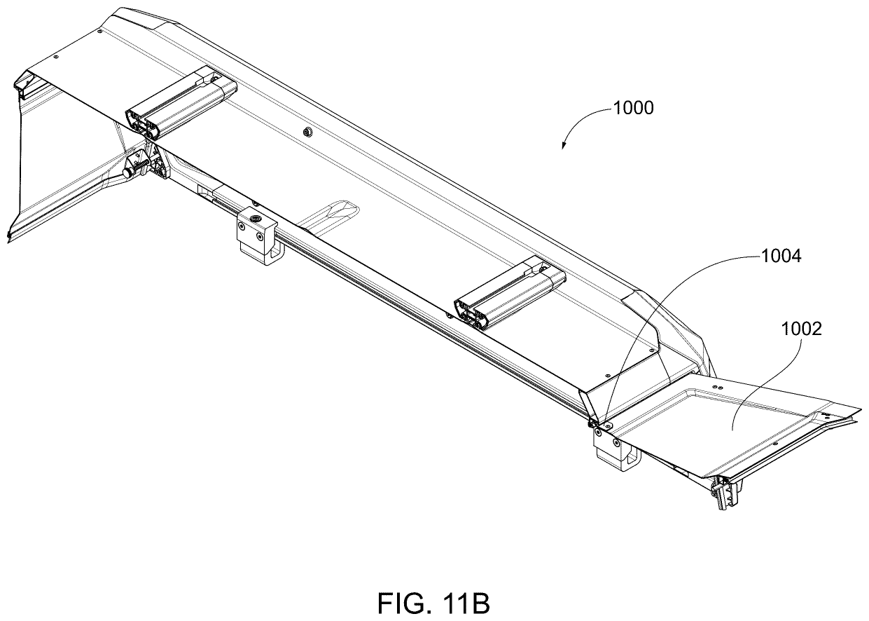

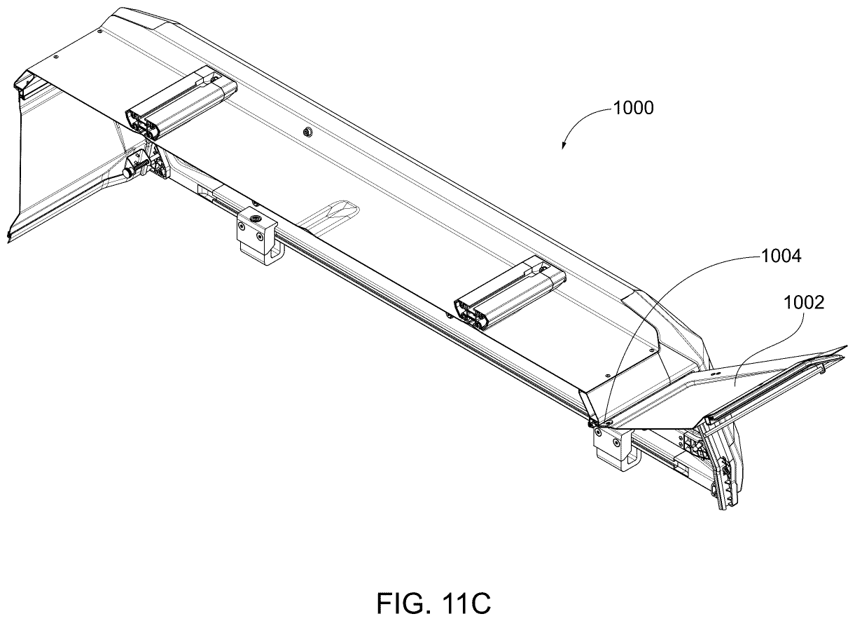

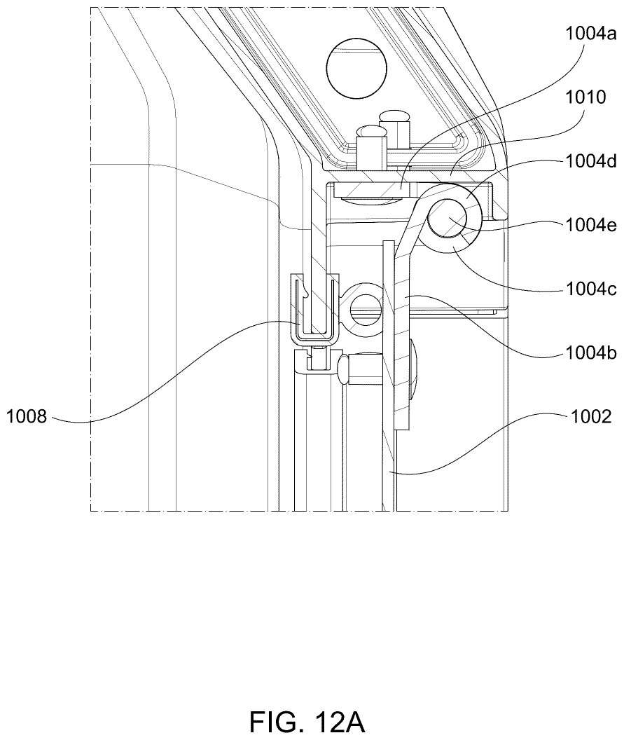

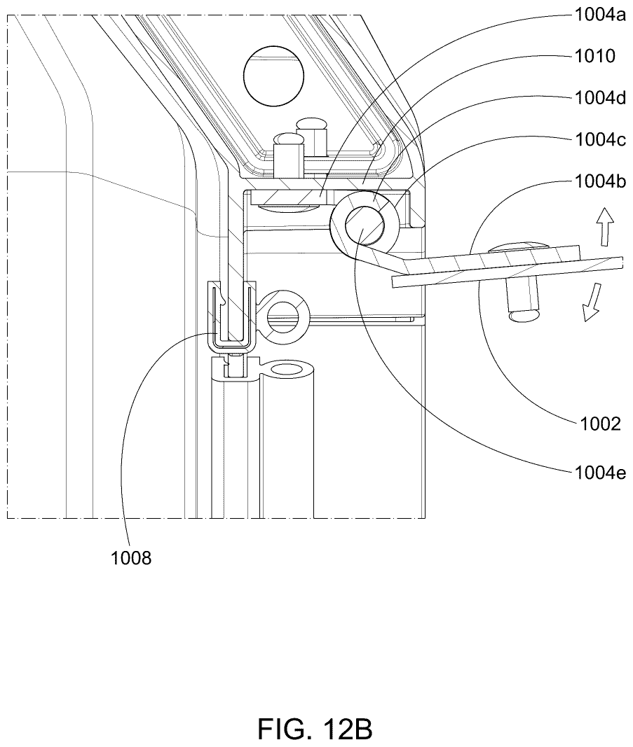

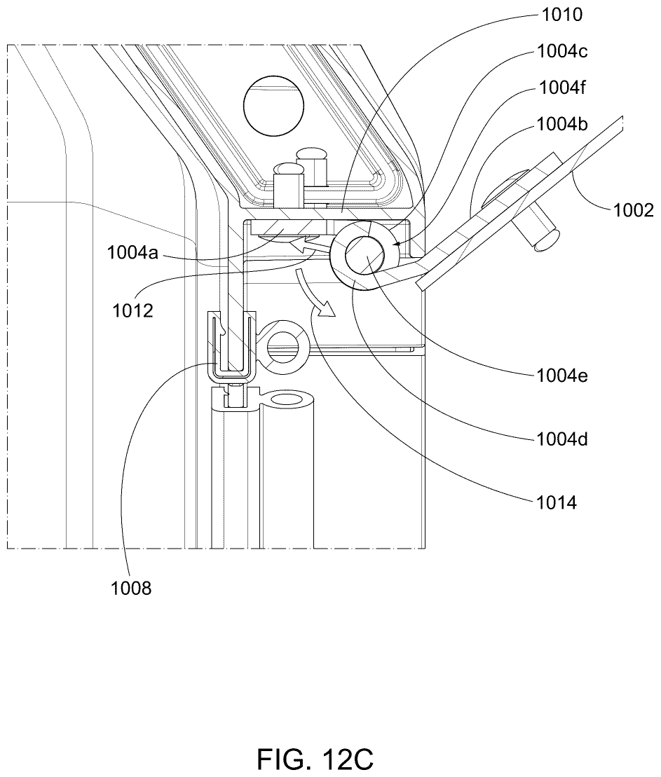

FIGS. 11A, 11B, and 11C depict cross-sectional views on a plane that cuts through one embodiment of the disconnecting hinges 1004 in closed, open, and over-rotated positions. FIGS. 12A, 12B, and 12C depict a close-up cross-sectional view of the hinge 1104 in each of the configurations of FIGS. 11A, 11B, and 11C and in the planes shown in those figures, respectively.

Referring to FIGS. 12A, 12B, and 12C, an embodiment of a disconnecting hinge 1004 is depicted in a cross-sectional view. In some embodiments of the hinge 1004, the two leaves of the hinge may be disconnected by rotating the access door 1002 to the over-rotated position and then translating the two hinge components relative to one another to separate them. Once the leaves are separated the door 1002 is disconnected from the utility rack 1000. Reattaching the door 1002 reverses the process and is also quick and does not require tools.

The depicted embodiment of the inventive hinge 1004 has a first leaf 1004a that is attached to a frame member or panel of the depicted rack 1000. The attachment may be rivets, bolts, screws, welding, adhesive, or any other fastening mechanism suitable for this application, or any combination of the foregoing fasteners. In some embodiments, the leaf 1004a may be part of or formed unitarily with a sheet or panel of larger size. In this embodiment one or more hinge barrels 1004c is attached to the first leaf 1004a. In the depicted embodiment the hinge barrel 1004c comprises two segments separated by a space. Similarly, a second leaf 1004b is attached to the access door 1002, and a hinge barrel 1004d is attached to the second leaf 1004b. In this embodiment the barrel 1004d of the second leaf is disposed in the space between the two segments of the hinge barrel 1004c. In other embodiments of the hinge 1004, the configuration of the hinge barrels 1004c and 1004d may be interchanged, or there may be more segments in each barrel 1004c and 1004d. In the varying embodiments, the lumens of the barrels 1004c and 1004d interlock so that the pin 1004e may be inserted through the entire length of the barrels 1004c and 1004d. In other embodiments each hinge 1004 may have multiple pins 1004e.

In this embodiment, a hinge pin 1004e is disposed through the lumen(s) of the hinge barrel 1004c and may be secured therein by any means that may be known to one of skill such as bolt head and nut features, a cotter pin, partial threads, welded attachment, or other similar mechanisms. In the depicted embodiment, the hinge barrel 1004d also has a semi-enclosed lumen for receiving the hinge pin 1004e, but there is a longitudinal gap 1004f in the hinge barrel 1004d extending the full length of the barrel 1004d and sufficiently wide to allow passage of the hinge pin 1004e through the gap.

In some embodiments the gap 1004f is sufficiently wide to allow passage of the hinge pin 1004e without deformation. In some embodiments the gap 1004f is slightly smaller than the diameter of the cylindrical hinge pin 1004e, and some deformation of the barrel 1004d is necessary for the gap 1004f to widen sufficiently to allow passage of the hinge pin 1004e. In practice, to remove the door 1002 the barrel 1004d is translated with respect to the hinge pin 1004e that is held in place with respect to the rack 1000. As the user translates the door 1002 the barrel 1004d moves as well and the hinge pin 1004e disengages from the lumen of the barrel 1004d.

In the inventive disconnecting hinge 1004, the hinge does not allow disconnection unless the hinge 1004 is in the over-rotated position. This limitation prevents unintended detachment of the access door 1002 when the door is in the closed position either accidentally or by unauthorized access. It also prevents undesired disconnection of the door 1002 when it is in the open position, which would be inconvenient for a user attempting to access the truck's cargo area through the door 1002.

In the depicted embodiment, disconnection of the hinge at an undesired position is prevented by a feature that interferes with or prevents translation of the barrel 1004d with respect to the pin 1004e when the door 1002 is in the closed position, the open position, and every position between them. In the depicted embodiment that feature is plate 1010 which in this embodiment is part of the frame or structure of rack 1000. With reference to FIG. 12A, feature 1010 is adjacent to the outer surface of barrel 1004d and is on the opposite side of the pin 1004e from the gap 1004f. In this position feature 1010 prevents translation of the barrel 1004d in the direction necessary for pin 1004e (which is fixed with respect to feature 1010) to move through gap 1004f. Similarly, in the open position depicted in FIG. 12B, feature 1010 still prevents translation of barrel 1010d in the necessary direction to disconnect the hinge 1004. However, in the over-rotated position similar to FIG. 12C or rotated a little further past open than shown, the feature 1010 is no longer opposed to the gap 1004f. In this position, the door 1002, the leaf 1004b, and hinge barrel 1004d are able to translate sufficiently in the direction of arrow 1012 to allow pin 1004e to pass through the gap 1004f so that hinge barrel 1004d can drop downwardly in the direction of arrow 1014, and the door 1002 will then be disconnected from the rack 1000. Reversing the process will reattach the hinge 1004 and the door 1002 to the rack 1000.

In some embodiments a bulb seal 1008 may be attached to the door 1002 or the rack 1000 to provide resistance to water intrusion. In some embodiments, the feature 1010 may be formed as part of the hinge leaf 1004a or as a protrusion or other component for attachment to the rack 1000.

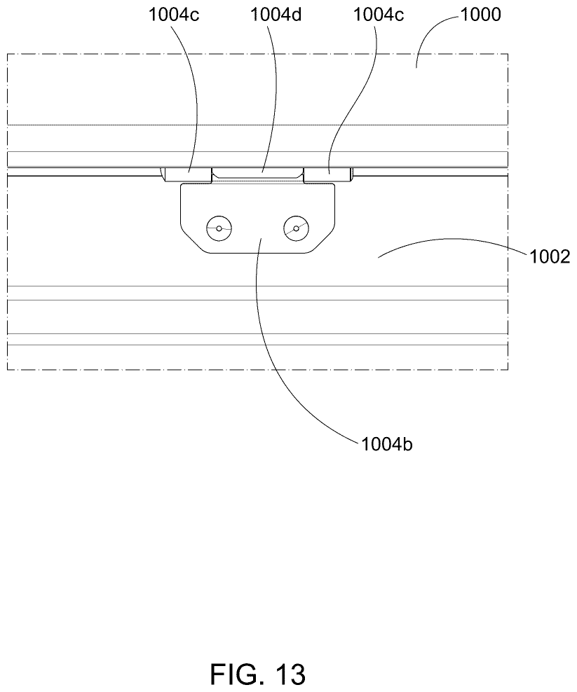

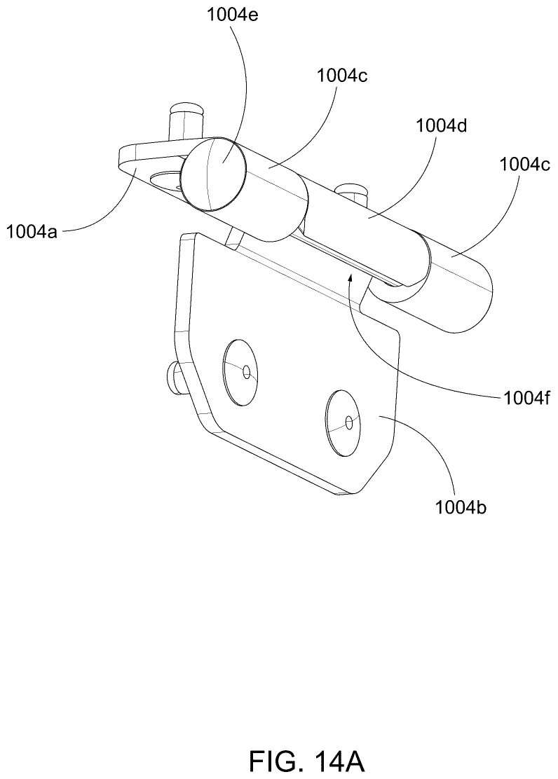

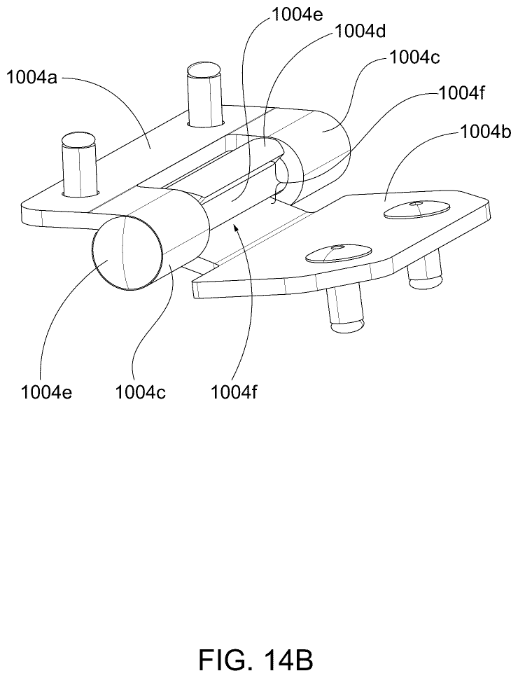

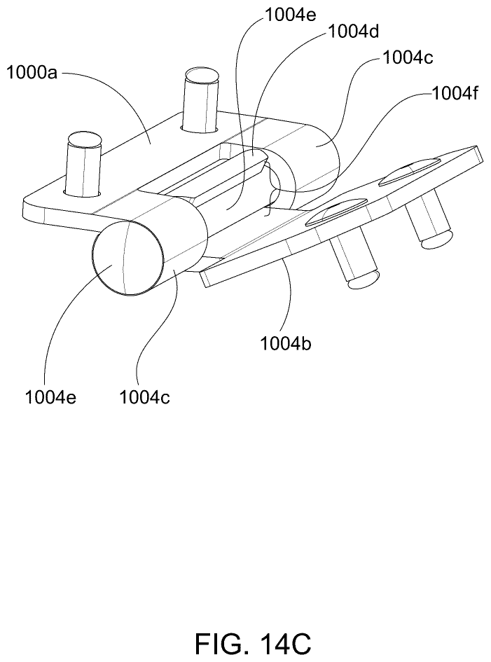

FIG. 13 depicts the hinge in the closed position. FIGS. 14A, 14B, and 14C depict an embodiment of the disconnecting hinge 1004, removed from the rack 1000 and access door 1002, in closed, open, and over-rotated positions, respectively.

In some embodiments internal attachment points may be provided on one or more of the access doors. These attachment points allow the attachment of cargo or cargo attachment panels for carrying equipment like traction boards, jacks, or other similar equipment. In some embodiments the cargo attachment panels may be permanently attached to the access doors such as by welding or riveting.

In some embodiments the frame for one or more of the access doors may support a cargo box disposed inside the utility rack. In these embodiments the access door may be opened to place cargo in the cargo box or remove it from the cargo box. The cargo box may form a sealed container when the access door is closed against the door frame.

The following item lists A, B, C, and so on are illustrative, but not limiting, of embodiments of the inventive utility rack. Features of the following item lists may constitute features of the other item lists. The reference numbers provided in the item descriptions are for ease of reference to the figures and shall not be construed as limiting their subject matter.

A1. A utility rack for carrying cargo on a truck comprising: an exoskeleton assembly comprising a first side frame, a second side frame, and at least two crossbars, wherein the first side frame and the second side frame are removably attached to a top surface of a first and second side wall of a bed of the truck, and wherein each of the at least two crossbars adjustably connect the first side frame to the second side frame; a top panel, a first side panel, a second side panel, a front panel, and a rear panel; wherein the top panel, first side panel, second side panel, front panel, and rear panel removably attach to the exoskeleton assembly to form a canopy over the bed of the truck; wherein all or a portion of the first side panel, second side panel, front panel, and rear panel may be detached from the exoskeleton while cargo is attached to the exoskeleton.

A2. The utility rack according to item A1, wherein one or more of the first side panel, second side panel, front panel, or rear panel are removably attached to the exoskeleton by a plurality of disconnecting hinge assemblies.

A3. The utility rack according to any of the preceding A items, wherein the disconnecting hinge assemblies comprise: a first leaf having a hinge barrel, the first leaf attached to one of the panels or the side frames; a second leaf having a hinge barrel, the second leaf attached to another of the panels; and a hinge pin for pivotally engaging the hinge barrels of the first and second leaves; wherein the hinge barrel of the second leaf has a longitudinal gap configured to allow the hinge pin to escape from the hinge barrel when the second leaf is in an over-rotated position.

A4. The utility rack according to any of the preceding A items, wherein the first leaf is attached to the top panel and the second leaf is attached to the rear panel.

A5. The utility rack according to any of the preceding A items, wherein the first leaf is attached to a side frame and the second leaf is attached to a side panel.

A6. The utility rack according to any of the preceding A items, wherein the top panel, when attached to the exoskeleton assembly, is disposed under the at least two crossbars such that cargo may be disposed on the at least two crossbars while the top panel is attached to the exoskeleton assembly.

A7. The utility rack according to any of the preceding A items, wherein the first and second side frames comprise continuous hoop shapes.

A8. The utility rack according to any of the preceding A items, wherein the side panels are attached to the side frames by quick release devices.

A9. The utility rack according to any of the preceding A items, wherein the side panels comprise an outer frame for attachment to the side frames and a door panel pivotally attached to the outer frame.

B1. A utility rack for a truck comprising an exoskeleton assembly (100), a roof panel (200b), a first side panel (200a), a second side panel (200a), a front panel (200e), and a rear panel (200c) removably attached to the exoskeleton assembly.

B2. The utility rack according to item B1, wherein the exoskeleton assembly (100) comprises a first side frame (100a), a second side frame (100a), and a plurality of crossbars (100b).

B3. The utility rack according to any of the preceding B items, wherein one or more of the side panels (200a) and rear panel (200c) are removably attached to the exoskeleton assembly by a plurality of disconnecting hinge assemblies (1004).

B4. The utility rack according to any of the preceding B items, wherein the disconnecting hinge assemblies (1004) comprise a first leaf and a second leaf, a hinge pin attached to the first leaf, the second leaf further comprising a hinge barrel with a longitudinal gap configured to allow the hinge pin to escape from the barrel when the second leaf is in an over-rotated position.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

1. A utility rack for carrying cargo on a truck comprising:
an exoskeleton assembly comprising a first side frame, a second side frame, and at least two crossbars, wherein the first side frame and the second side frame are removably attached to a top surface of a first and second side wall of a bed of the truck, and wherein each of the at least two crossbars adjustably connect the first side frame to the second side frame;
a top panel, a first side panel, a second side panel, a front panel, and a rear panel;
wherein the top panel, first side panel, second side panel, front panel, and rear panel removably attach to the exoskeleton assembly to form a canopy over the bed of the truck;
wherein all or a portion of the first side panel, second side panel, front panel, and rear panel may be detached from the exoskeleton while cargo is attached to the exoskeleton.

2. The utility rack of claim 1 wherein one or more of the first side panel, second side panel, front panel, or rear panel are removably attached to the exoskeleton by a plurality of disconnecting hinge assemblies.

3. The utility rack of claim 2 wherein the disconnecting hinge assemblies comprise:
a first leaf having a hinge barrel, the first leaf attached to one of the panels or the side frames;
a second leaf having a hinge barrel, the second leaf attached to another of the panels;
and a hinge pin for pivotally engaging the hinge barrels of the first and second leaves;
wherein the hinge barrel of the second leaf has a longitudinal gap configured to allow the hinge pin to escape from the hinge barrel when the second leaf is in an over-rotated position.

4. The utility rack of claim 3 wherein the first leaf is attached to the top panel and the second leaf is attached to the rear panel.

5. The utility rack of claim 3 wherein the first leaf is attached to a side frame and the second leaf is attached to a side panel.

6. The utility rack of claim 1 wherein the top panel, when attached to the exoskeleton assembly, is disposed under the at least two crossbars such that cargo may be disposed on the at least two crossbars while the top panel is attached to the exoskeleton assembly.

7. The utility rack of claim 1 wherein the first and second side frames comprise continuous hoop shapes.

8. The utility rack of claim 1 wherein the side panels are attached to the side frames by quick release devices.

9. The utility rack of claim 1 wherein the side panels comprise an outer frame for attachment to the side frames and a door panel pivotally attached to the outer frame.
